(19) United States
(12) Patent Application Publication
(10) Pub. No.: US 2006/0047535 A1
(43) Pub. Date: Mar. 2, 2006

(54) Method and system of business management

(75) Inventor: Richard Fredricksen, Sparta, NJ (US)

Correspondence Address: ARENT FOX PLLC, 1050 CONNECTICUT AVENUE, N.W., SUITE 400, WASHINGTON, DC, 20036, US

(73) Assignee: PAIVA Fredricksen Group, LLC

(21) Appl. No.: 11/165,204

(22) Filed: Jun. 24, 2005

Related U.S. Application Data
(60) Provisional application No. 60/604,496, filed on Aug. 26, 2004.

(51) Int. Cl. G07G 1/00; G06F 15/02; G06F 17/30

(52) U.S. Cl. 705/1; 705/9; 705/10

(57) ABSTRACT

A method and system for uniformly presenting, communicating, and implementing an idea through an organization's structure or portion thereof. The management method and system ensure that an original idea formulated at upper levels of a business or organization is implemented through the business or organization's hierarchal structure without being modified or miscommunicated to others within the levels of the organization's hierarchal structure. The method and system ensure that the original business idea is presented with the same meaning, in the same context, and with the same emphasis across each level of the cascade. A uniform method and system are provided for teaching employees or members of the business or organization to remove practical problems generally observed with conveying an original idea throughout the cascade.

### CROSS-REFERENCE TO RELATED APPLICATION

This application claims the benefit of U.S. Provisional Application Ser. No. 60/604,496 filed Aug. 20, 2004, which is incorporated herein by reference in its entirety.

### BACKGROUND OF THE INVENTION

1. Field of the Invention

The present invention relates to a method and system of business management, and in particular to an automated application used by consultants and business employees to improve aspects of a business.

2. Description of Related Art

A business organization, such as a corporation, typically consists of personnel, including management and employees (collectively and interchangeably referred to herein as “members” or “employees”). The personnel are normally organized in a hierarchal structure (interchangeably referred to herein as a “cascade” or “personnel cascade”), wherein top ranking employees interact with lower ranking employees 1) to delegate tasks, responsibilities, or projects; 2) to institute business policies, procedure, or strategy; and/or 3) to provide business-related information generally. This interaction may be referred to generally as communicating a “business idea” or “business implementation.” The lower ranking employees may communicate the business implementation with even lower employees. Generally, the cascade is observed throughout the personnel hierarchy from the highest level of management to the lowest ranking employees.

Ideally, the cascade therefore allows the business to achieve its goals in an efficient manner. The business implementation communicated through the cascade can be spread quickly throughout the business and, in some cases, allows the business implementation to be simultaneously performed by numerous employees. One example of the cascade is seen in the case of upper management of a business having a business implementation to be applied business-wide, in which management relies on the cascade to spread the idea to each intended employee and to ultimately implement the idea.

For example, in a first step of an exemplary cascade, a senior executive communicates the business idea or implementation to the executive's ten division managers, who each manage a division with ten employees. In a second step of the cascade, the division managers communicate the idea or implementation to the one hundred employees working in the ten divisions. In this example, there are only two levels (also interchangeably referred to herein as “steps”) in the cascade. In an ideal business setting, the parameters of the original idea, which is the idea as envisioned by the senior executive, is implemented by each of the one hundred employees. The cascade allows the ten division managers to understand their roles, and then to instruct their employees on the employees' roles in implementing the idea.

However, the cascade described above, i.e., the flow of information through the business, is often unattainable in many businesses. For example, the cascade may fail because the conveyance of the business idea or implementation from the originating party (e.g. senior management) to the intended recipients (e.g. junior management and junior employees) fails. Typically, the more complex the personnel hierarchy of a business, e.g., the greater the number of steps in the cascade, the more likely the cascade is to fail.

Failure is generally characterized by a breakdown of one or more steps in the cascade. For instance, a breakdown may include a misunderstanding of the business idea by a recipient, thereby preventing the recipient from implementing or further conveying the idea. Additionally, a breakdown may entail an inability by the recipient of the business method to delegate, supervise, or initiate an assignment integral to the business idea. Often, a breakdown may be categorized as the deliverer misconveying the original business idea, the recipient misconstruing the idea, or one or more participants failing to act on the idea. From step to step in the cascade, with failure, there is a discontinuity in the communication of the original idea, and often this discontinuity amplifies to the point where the original idea is completely lost or hidden. Furthermore, the original idea may be distorted into variations, which are interchangeably referred to herein as the “altered idea” or the “deviated idea.” As a result, the business idea is not implemented as originally intended.

An example of how the original idea becomes altered can be seen in a modified example involving one senior executive, ten division managers, and ten employees per division. The senior executive conveys the original idea to the division manager, but the interpretation of the idea by the division manager is not exactly what the executive intended or attempted to convey. The division manager, however, conveys the division manager's understanding of the business idea, i.e., the altered idea, which includes the division manager's interpretation, to division manager's ten employees. As a result, the division manager and the division manager's ten employees incorrectly implement the business idea due to the breakdown in the cascade. It is conceivable that by the time the business idea reaches the employees, the original idea has little or no meaning or effect. As a result, the business is unable to reap the potential benefits of the original idea.

One way to ensure that the cascade works successfully is to ensure that each level of the cascade (e.g., top executives, regional managers, district managers, site managers, hourly employees) completely understands the original idea, can perform the duties required, and is able to articulate, convey, and supervise the responsibilities of the original idea to the next level of the cascade. This ideal, as stated earlier, is extremely difficult to achieve in the existing art.

Businesses have often hired consultants to ensure that the cascade runs smoothly and efficiently. In a typical business consulting engagement between consultants and a business, the consultants meet with one or more client leaders, who are likely senior executives or project managers, for example, to understand the client's needs and to understand the parameters of the original idea to be implemented by the business. For example, the idea may include implementing a new management structure, introducing a new marketing strategy, or developing a new product line. Generally, the consultant is brought to the business to help implement the idea or to enhance the acceptance of the idea.

The consultants typically obtain an organizational chart, illustrating the cascade and responsibilities associated with each employee or step in the cascade. Generally, consultants meet with each member listed on the chart. However, the addition of consultants may fail to solve or may even contribute to the problem. In particular, often the consultants add another layer of potential discontinuities between the original idea and the idea as it is received. For example, consultants may unintentionally reinforce their own variations of the original idea, thereby creating a breakdown in the cascade.

Thus, in the prior art, there is no systematic way for a business to ensure that the cascade is highly effective and that an original idea relayed from the top levels of the cascade reaches the bottom level of the cascade, even with the assistance of consultants. This problem is exacerbated as cascades become larger, as is typical in multinational corporations and Fortune 500 companies.

There remains an unmet need in the art to provide methods and systems to ensure that the cascade to convey business ideas and implementations works effectively. More specifically, there is an unmet need in the art for ensuring that each employee at every step of the cascade performs the employees' responsibilities relating to the original idea. There is a further unmet need in the art for methods and systems for consultants to effectively ensure that the original idea properly flows through the cascade in order to have a productive implementation of the original idea.

### SUMMARY OF THE INVENTION

The present invention relates to a method and system for ensuring that cascades running through a business or organization uniformly present and carry out ideas and implementations. Embodiments of the present invention provide a method and system via a software application through a network, such as the World Wide Web (interchangeably referred to herein as the “Internet”), for facilitating interaction among the consultant (interchangeably referred to herein as a “coach”) contracted (or hired or assigned) by the business or organization (interchangeably referred to herein as a “client”) and each employee of the client. In particular, the present invention provides a uniform method and system for a coach to teach employees to remove practical problems generally observed with conveying an original idea throughout the business cascade. More specifically, the present invention ensures that the original idea is presented with the same meaning, in the same context, and with the same emphasis across each level of the cascade.

The present invention inherently addresses two critical elements of the cascade: 1) institutionalizing the original idea of the business, and 2) developing a method of communicating (and reinforcing) the original idea among personnel.

First, the present invention ensures that the logic steps of strategy execution are communicated, understood, and implemented. In order to accomplish this goal under the method and system of the present invention, the original idea, as developed, is made explicit, for example, by inputting the original idea into digital (interchangeably referred to herein as “electronic”) memory or by otherwise memorializing the original idea, such as by putting it in writing. In one variation, the developers of the original idea review the idea as inputted to ensure that the idea as inputted reflects the intent, meaning, and purpose of the original idea.

The inputted original idea, particularly in digital form, allows the business to easily share and present the original idea to multiple employees or other parties, including remotely located parties, without deviation from the original idea. Thus, this feature of the present invention creates uniformity in the sharing and presenting of the original idea. For example, in a large, multi-office business, the original idea is posted on a server on a network, such as the Internet or an intranet, to allow electronic access by every employee. In this example, each person can view the original idea in its entirety. In another variation, each person can view responsibilities assigned thereto under the original idea.

Second, the present invention provides a system and method for teaching, enforcing, and reinforcing the original idea at every step of the cascade of the business. For example, in one embodiment of the present invention, the automated system ensures that each employee understands, conceptualizes, and applies the idea, by providing interactive tools and lessons to the employee while being supervised by the coach. In one variation, the coach is a human instructor able to interact with the employee in real-time. In another variation, the coach is an automated system component that engages each employee.

Other features of the present invention will become apparent from the following detailed description considered in connection with the accompanying drawings, which disclose multiple embodiments of the present invention. It should be understood, however, that the drawings are designed for the purpose of illustration only and not as a definition of the limits of the invention. Additional advantages and novel features of the invention will also become more apparent to those skilled in the art upon examination of the following or upon learning by practice of the invention.

### BRIEF DESCRIPTION OF DRAWINGS

Other aspects of the present invention will be better understood from the following description, along with the accompanying drawings, wherein:

FIG. 1 is a flowchart of a system and method for implementing a business idea, in accordance with an embodiment of the present invention;

FIG. 2 is a flowchart of a step labeled “D” of the flowchart of FIG. 1;

FIG. 3 contains a block diagram of various computer system components for implementation of a business idea, in accordance with an embodiment of the present invention;

FIG. 4 presents an example system and method for implementing a business idea diagram for use via a network, such as the Internet, in accordance with an embodiment of the present invention;

FIG. 5 shows an individual user login graphical user interface (GUI) screen, in accordance with an embodiment of the present invention;

FIG. 6 shows a main page GUI screen, in accordance with an embodiment of the present invention;

FIG. 7 illustrates a new session creation GUI screen, in accordance with an embodiment of the present invention;

FIG. 8 is an execution module selection GUI screen for a Functional Leader session, in accordance with an embodiment of the present invention;

FIG. 9 is an example GUI screen showing instructions and intent of a Business Purpose submodule of a Clarity execution, in accordance with an embodiment of the present invention;

FIG. 10 illustrates a function of an Image Map navigation bar, in accordance with an embodiment of the present invention;

FIGS. 11 and 12 illustrate a business purpose input GUI screen of the Business Purpose submodule, in accordance with an embodiment of the present invention;

FIGS. 13 and 14 show a roles and responsibilities input GUI screen of the Business Purpose submodule, in accordance with an embodiment of the present invention;

FIG. 15 is an example GUI screen showing instructions and intent of a Metrics and Goals submodule of a Clarity execution, in accordance with an embodiment of the present invention;

FIG. 16 is metrics and goals input GUI screen of the Metrics and Goals submodule, in accordance with an embodiment of the present invention;

FIG. 17 shows a metrics pyramid GUI screen illustrating a hierarchal structure, in accordance with an embodiment of the present invention;

FIG. 18 shows the stakeholder goals input GUI of the Metrics and Goals submodule in screen, in accordance with an embodiment of the present invention;

FIG. 19 is an example GUI screen showing instructions and intent of a Business Proposition submodule of a Clarity execution according to an embodiment of the present invention;

FIG. 20 is a deliverables input GUI screen of the Business Proposition submodule, in accordance with an embodiment of the present invention;

FIG. 21 illustrates a Leader's Mix input GUI, in accordance with an embodiment of the present invention;

FIG. 22 shows a first GUI screen of a Leadership Integrator for the Business Proposition submodule, in accordance with an embodiment of the present invention;

FIG. 23 illustrates an execution module selection GUI screen of a Project Leader session, in accordance with an embodiment of the present invention;

FIG. 24 is an example GUI screen showing instructions and intent of a Business Purpose submodule of a Project Clarity execution, according to an embodiment of the present invention; and

FIGS. 25-27 illustrates graphically displayed information GUI screens of a Process Tracking submodule, in accordance with an embodiment of the present invention.

### DETAILED DESCRIPTION OF THE INVENTION

The present invention relates to a method and system for uniformly presenting, communicating, and implementing an idea through an organization's structure or portion thereof. The management method and system of the present invention ensures that an original idea formulated at upper levels of a business or organization is implemented through the business or organization's hierarchal structure (i.e., cascade) without being modified or miscommunicated to others within the levels of the organization's hierarchal structure. The present invention ensures that the original idea is presented with the same meaning, in the same context, and with the same emphasis across each level of the hierarchal structure of the business or organization. Moreover, the present invention provides a uniform method and system for teaching employees or members of the business or organization to remove practical problems generally observed with conveying an original idea through the cascade.

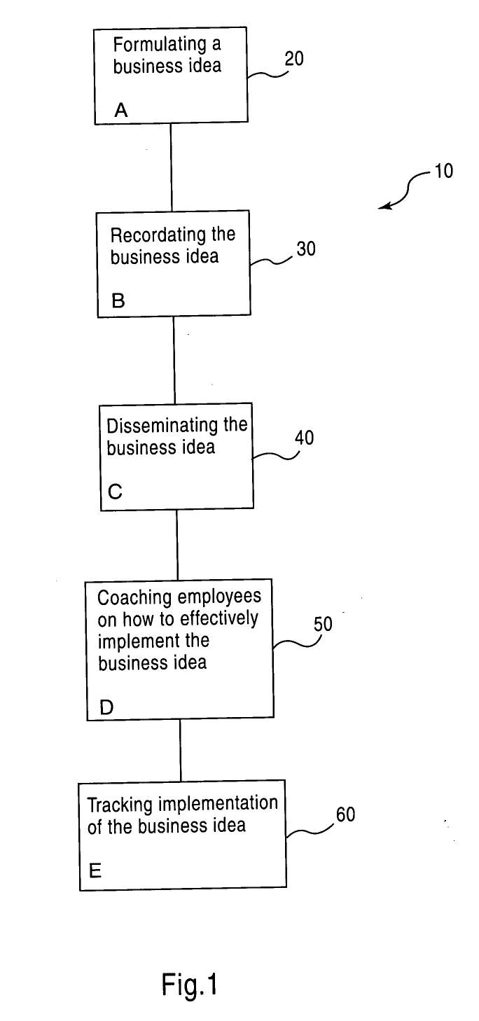

FIG. 1 illustrates a flowchart 10 of a method and system of business management, particularly for communicating and/or implementing a business idea within a business or organization according to an embodiment of the present invention. Step 20 represents genesis of the business idea, wherein, for example, upper management formulates an idea for transfer to or implementation by lower lever employees or members of the business or organization. Step 30 involves recording or memorializing the business idea, wherein employees or members of the business or organization may refer to the business idea in an unaltered state. Step 40 involves disseminating the business idea throughout each level of a business or organization, wherein each employee or member becomes aware of the business idea. Step 50 represents a coaching step for coaching employees or members, such as employees or members who have managerial responsibility over other employees or members (e.g., leaders). During the course of or after being coached, the leaders are responsible for communicating and implementing the business idea with the employees or members for which the leaders are responsible. Step 60 involves monitoring the implementation of the business idea within the business or organization.

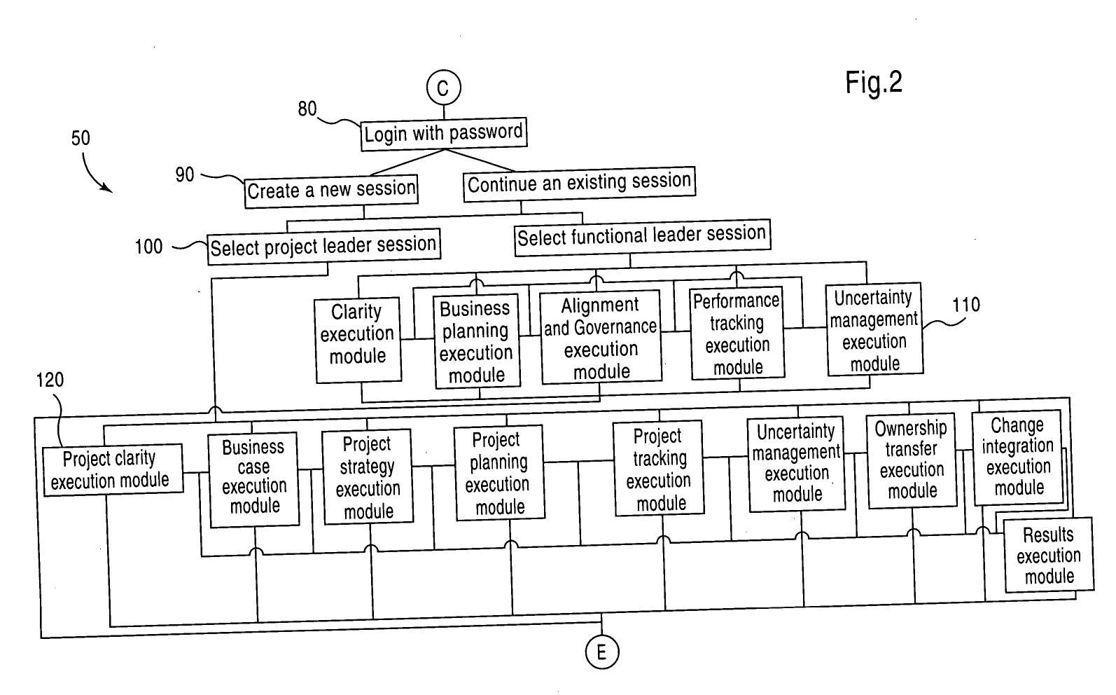

FIG. 2 is a flowchart representing a more detailed illustration of the coaching step 50, in accordance with an embodiment of the present invention. Step 80 represents logging into or otherwise accessing a system for implementing a business idea. Various levels of logon may be provided, so as to permit individual access based on authorization. At step 90, the employee creates a new coaching session or continues with a previously created coaching session. The employee then selects a type of coaching session at step 100, such as a Functional Leader session or a Project Leader session. The Functional Leader and Project Leaders sessions are discussed in more detail below. Step 110 identifies a plurality of execution modules included within the Functional Leader session according to an embodiment of the present invention. Further, in some embodiments, the employee may begin with any execution module within the Functional Leader session, e.g., the employee is not required to advance through the execution modules in a linear fashion. Step 120 illustrates a plurality of execution modules within the Project Leader session, according to an embodiment of the present invention. Similarly, in some embodiments, the employee is not required to advance through the execution modules in any particular order. The execution modules associated with the Functional Leader session and the Project Leader session are explained in more detail below.

In one embodiment of the present invention, at least one employee enters a network location (interchangeably referred to herein as a “website” or “document” or “file”) by entering search information, such as identification information (interchangeably referred to herein as a “login”) and a password. Each employee has a unique login and password, for example, and can only access data specific to that employee, in one variation of the present invention. In another variation, information is input by a coach while working with the employee, rather than the employee.

In another variation, the coach also enters a login and password to access the site. The coach is provided with a series of files, each corresponding to an individual employee of the client, for example. The coach selects the file concerning the particular employee logged onto the network, e.g., the employee who is undergoing training with the coach. In one variation of the present invention, the coach is a person interacting with the employee in real-time. Alternately, the coach accesses the employee information at a different time. In yet another variation, the coach may be or include pre-programmed automated responses for interacting with the employee, based on the employee's electronic input.

Once the coach and employee have established communication through, for example, a central server or website, the coach and employee engage in dialogue to teach, enforce, and reinforce the original idea of the business. In one variation of the method and system of the present invention, the coach reviews the employee's understanding of the business process by engaging the employee in a logic process (interchangeably referred to herein as “logic stream”). This logic process is an interactive process wherein the coach poses questions and/or problems for the employee, and the employee responds accordingly. In one variation of the present invention, the response is open-ended, meaning the employee provides unscripted responses to the coach's inquiry.

For example, the coach provides the employee with a series of questions (e.g., written interrogatories), which the employee preferably answers and/or completes electronically. The employee electronically submits the answers, and subsequently the coach reviews the answers to determine whether the employee possesses a requisite understanding of the subject matter. In this context, the consultant or the client defines the requisite understanding needed by the employee. The coach then provides feedback to the employee, in one variation of the present invention. If necessary, the coach engages in additional metrics (e.g., questions to gauge the employee's knowledge, skill or understanding of a matter, such as the original idea) with the employee to test the employee. Each metric involves providing the employee with a task, reviewing the task, and providing feedback to the employee.

In many situations, the metrics are supplemented by instructional material. This material is presented by the coach during the training session to provide the employee with assistance, and may include factual information useful to the employee, such as an explanation of the original idea, tips to organize subordinate employees, and strategies for implementing projects. In one variation, the coach records the employee's comprehension of the material presented.

After compiling and analyzing the data obtained through the metrics or presentations from each employee, the coach provides the results of the data to the client leader. In one variation, the client leader requests further interaction by each employee, or at least the employees showing less comprehension of the business idea. Alternatively, the client restructures the original idea to fit the employee comprehension of the idea.

One exemplary embodiment of the present invention will now be described. Using a terminal, such as a personal computer (as described infra), the coach (interchangeably referred to as a “user” in the context of operating the present invention) accesses a server or a network, such as the Internet, by entering a login and password. The first graphical user interface (GUI) screen accessed is referred to as the “main page,” which allows the user to 1) address administrative functions (e.g., changing the user's login or password); 2) view a demonstration, or overview of the software application; 3) start a new session; 4) generate reports of the session or reports of data for a personnel team; or 5) enter an existing session. A session generally includes potential interaction with all interactive activity between a coach and the employee of the client, data collected, reports generated, and information presented.

After entering a new session or an existing session, the user is able to perform numerous administrative functions or begin the substantive coaching. The administrative functions include, for instance, logging out, changing sessions, contacting the administrators, and reviewing a demonstration or overview of the system.

Each session also allows the user to perform substantive coaching. The sessions are based on the training goals for the business' employees, which vary from long term to short term goals. The goals also vary from specific ideas, such as project implementations, to general institutional business ideas, such as changes in business culture. In one variation, there are two primary training platforms to address the implementation of specific ideas and institutional business ideas: a functional leader and a project leader. The functional leader generally encompasses business-wide strategy and implementation. The project leader generally focuses on team management as applied to accomplish a finite or particular goal.

As a result, the two platforms focus on different employee comprehension, skills, and development and apply varying tools and interactions for the coach and employee. Each platform includes categories of training, such as leadership training, communication training, and team-building training. Within each category are modules and submodules, which provide specific lessons and presentations, and tools to teach, execute, enforce, and reinforce business skills. The platforms differ with regard to which categories, modules, and particularly submodules are activated (e.g., so as to be operational and useful to the training).

In one embodiment of the present invention, the Functional Leader platform focuses on changing institutional aspects of the business and includes general categories of personnel training, such as Strategy, Transactional, Leadership, Communication, and Alignment.

The Strategy category includes the following execution modules, in one variation: clarity, business planning, and alignment and governance. The Clarity execution module assists the coach in focusing the employee on the basics regarding the business idea. In one variation, the coach asks the employee about the fundamental tenets of the business, e.g., why the business exists and what responsibilities are held by certain employees. In another example, the employee is asked to explain the duties and responsibilities of the employees directly above and below the employee in the cascade, as well as the employee's own duties and responsibilities. In another example, the employee is asked to describe the benchmarks (interchangeably referred to herein as “metrics”) that would generally assist in assessing performance of the employee, the team, stakeholders, superiors and inferiors. In yet another variation, the employee details how each day is spent and explains any gaps in the day. The employee submits the responses to the coach, who reviews the responses for content. Generally, the coach provides feedback to the employee, such as additional information needed to improve or refine the employee's skills.

The coach and employee also develop business plans in the Clarity execution module. In particular, the employee and coach develop performance levels for the employee, for the employee's staff, and/or for employees one level below and above in the cascade. The employee is asked, for example, to provide a vision statement, to explain of the metrics for assessing performance (e.g., deliverables), and to explain how tasks are performed or implemented.

The coach then works with the employee to align and govern the employee's understanding of the business, as observed and determined through the data collected in the previous execution modules, with original ideas, as envisioned by the business. Moreover, the coach and employee work to develop factors for success, and to account for and manage risks potentially impeding success.

The Transactional category includes execution modules, such as performance tracking and uncertainty management. The Performance Tracking execution module includes numerous submodules relating to eliciting and organizing plans, as well as developing meaningful status and progress checks for the business. Under the Transactional category, the coach and employee also review, enumerate, and assess the potential for impediments to performance. The uncertainty management submodule provides an open-ended dialog box for the employee to input the employee's views regarding these matters.

In one embodiment, three additional categories, Leadership, Communication, and Alignment, provide coaches with instructional and training tools for the employees. The Leadership category provides the coach with a step-by-step review and evaluation of the employee's leadership skill. In the present embodiment, the Leadership category includes execution modules directed to, for example, presentations on the roles and criteria for, and ways of becoming a leader, as well as tools to enhance the employee's and the employee's staff's leadership skills.

The Communication category includes presentations and tools to develop the employee's ability to communicate effectively across a spectrum of fora, including personal one-on-one interaction and public engagements before audiences. Accordingly, one embodiment of the present invention includes execution modules to enhance day-to-day written and oral communications skills, to enhance presentation delivery, and to manage meetings.

The Alignment category includes tools and development workshops to improve the employee's overall business acumen and to introduce and/or reinforce general business skills, such as networking. Under the Organizational Dynamics execution module, the coach presents the employee with a comprehensive view of the business cascade, expectations of each employee, and factors for success in the business. The teachings of the Organizational Dynamics execution module are reinforced in development tools, which are intended to teach the employee methods for enhancing the employee's staff's performance. For instance, the “What's In It for Them (WIFT)” tool asks the employee to present or brainstorm on the incentives and motivations for the employee's staff to perform at an optimal level. As with each interactive tool, the coach reviews the answers and ensures that the answers meet the desired results, which are optionally selected by the business. A stakeholder management execution module covers the employee's interaction with business vendors and other employees within the business who are not under direct supervision of the employee, such as mailroom employees. This execution module also covers reinforcing the overall business culture, in one variation.

In one embodiment of the present invention, the Project Leader platform includes six categories: 1) Business Case, 2) Implementation, 3) Sustain, 4) Leadership, 5) Communication, and 6) Alignment. The latter three categories have been described previously under the Functional Leader platform, and generally provide similar user functions and features to those previously described.

In the present embodiment, the Business Case category relates to reviewing and understanding the project assigned to the employee or the employee's staff, including the reasons for conducting the project from the business' perspective and details regarding the scope of the project. The coach and employee work through numerous execution modules to develop skills to organize and prepare for a project assigned to the employee. For example, related submodules include reviewing the substance of the project, understanding the significance of the project, developing goals and/or measures of performance to assess progress on the project, and composing the team to address the project. The coach interacts with employees using several execution modules, such as developing a work plan and enhancing decision processes. Additionally, the Business Case execution module includes tools and guides to understand the costs/benefits, realizations, and impact of the project. Moreover, the Project Strategy execution module provides numerous submodules to prepare for the project. For instance, submodules include tools to develop project outlines, work streams, overviews, scope analysis, core analysis, and risk analysis.

The Implementation category is directed to finalizing the planning for the project, engaging in the project, and developing feedback and status mechanisms to ensure the project is operating smoothly. Execution modules include Project Planning, Project Tracking, and Uncertainty Management, in one embodiment of the present invention. Each execution module includes interactive training submodules to assist with employee development in these areas.

The Sustain category addresses actions taken on a project after implementation and before launch or completion of the project. In one variation, the execution module prepares the employees developing the project to go “live,” which means the application as a result of the project is fully functional for its intended users. For example, one submodule provides training and guidance to employees on transferring the project to other areas of the business. The Change Integration execution module reinforces a series of interactive checklists, of which employees should be mindful when transferring control of the project. The Results execution module is used by coaches to inquire as to whether the project has achieved the project's predicted goals and to assess the employee's satisfaction with the project. Moreover, the coach and employee review the benefits of the project to determine if the predicted benefits were observed, and review the design and implementation of the project in order to obtain generalizations, feedback, and lessons that may be used in future or other projects.

The categories, execution modules, and submodules are not limited to those listed above. For example, employee training using the present invention may include all aspects of business management, and therefore other categories, execution modules, and submodules concerning business management may be used. In addition, additional platforms may be included in the present invention. For instance, platforms may include, Short-Term Strategies, Long-Term Strategies, and Business Globalization, among others.

Example Processing System Components and Functionality

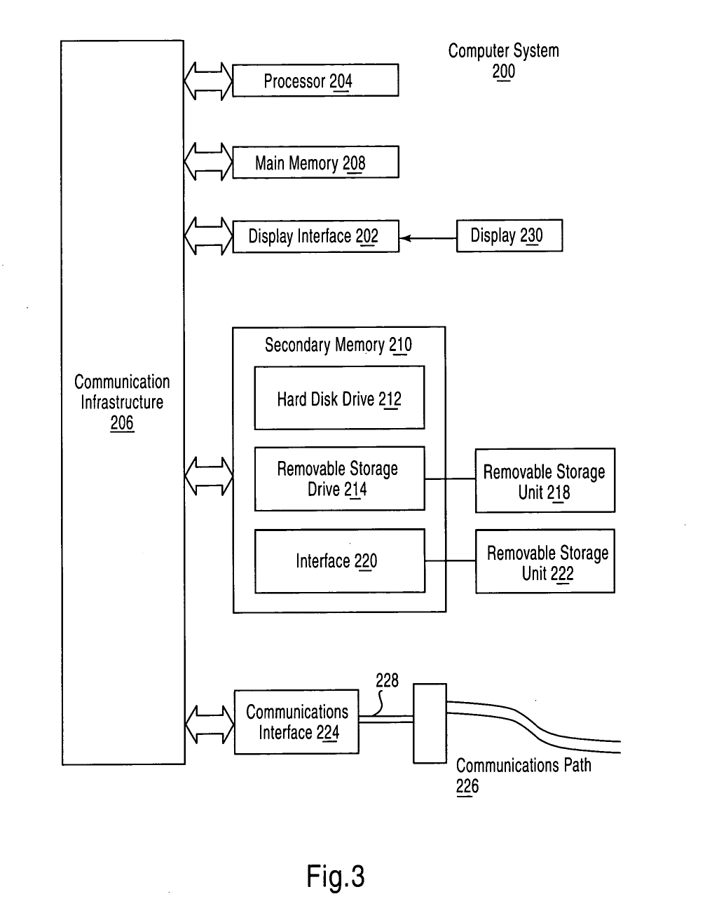

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system is shown in FIG. 3.

As shown in FIG. 3, computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical, or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link, and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

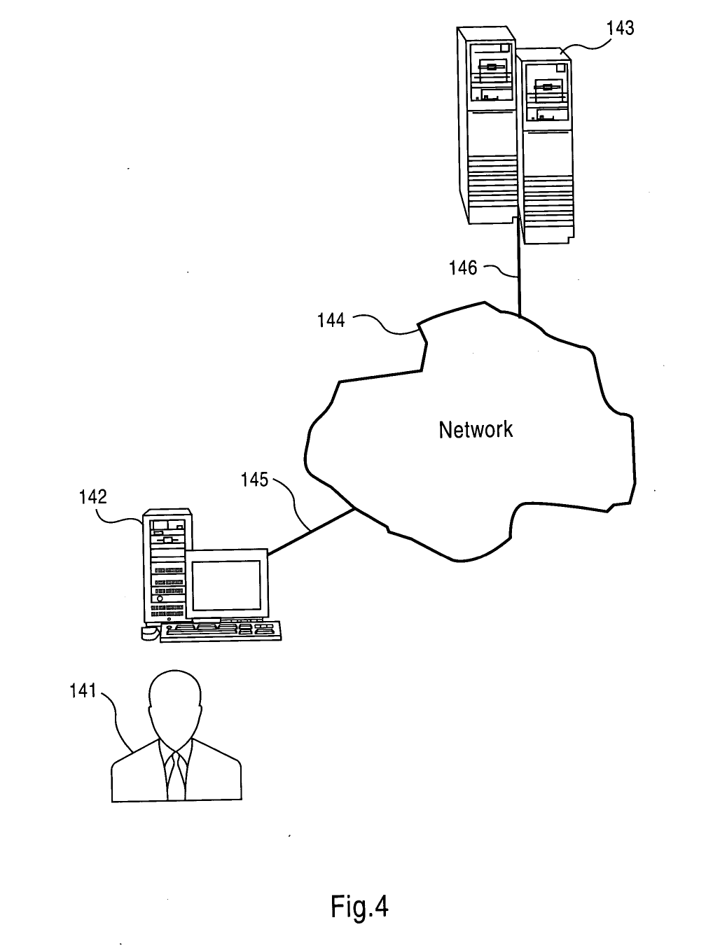

As further shown in FIG. 4, in one embodiment of the present invention implemented via a network, the system components include a terminal 142, such as a personal computer (PC), minicomputer, main frame computer, microcomputer, telephone device, hand-held device, or other device having a processor and input/output capability, accessed by a user 141 that is coupled to a server 143, such as a PC, minicomputer, main frame computer, microcomputer, or other device having a processor and a repository for data or connection to a repository for maintained data, via a network 144, such as the Internet, via couplings 145, 146, such as wired, wireless, or fiber optic connections.

Features of Exemplary GUI Interface for a Method and System for Implementing a Business idea

Embodiments of the present invention include one or more GUI screens to assist a user with completing various aspects of the method and system of business management. Various features of the GUI screen portion of the present invention will now be described in further detail.

An embodiment of the present invention includes a number of standard features for ensuring security for accessing variations of the present invention for use on networks, such as the Internet or an intranet, or elsewhere, and for confirming individual authorization for access of the system. In addition, such security can be used to vary the user's access to various portions of the system (e.g., one level may permit information to be input, but not permit alteration of preset requirements; another level of user may also allow varying of system requirements and generation of reports).

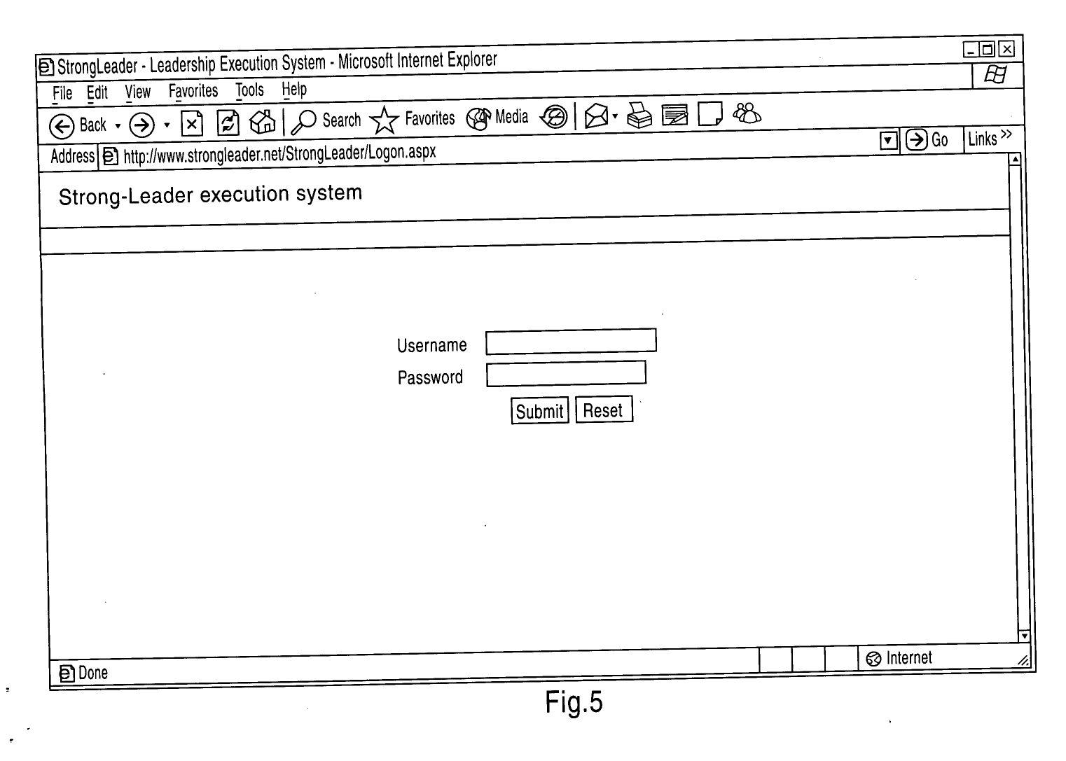

The coach and/or an employee of the business (interchangeably referred to as “user”) enter a network location (interchangeably referred to herein as a “website” or “document” or “file”) by, for example, entering a login and password, as shown in FIG. 5.

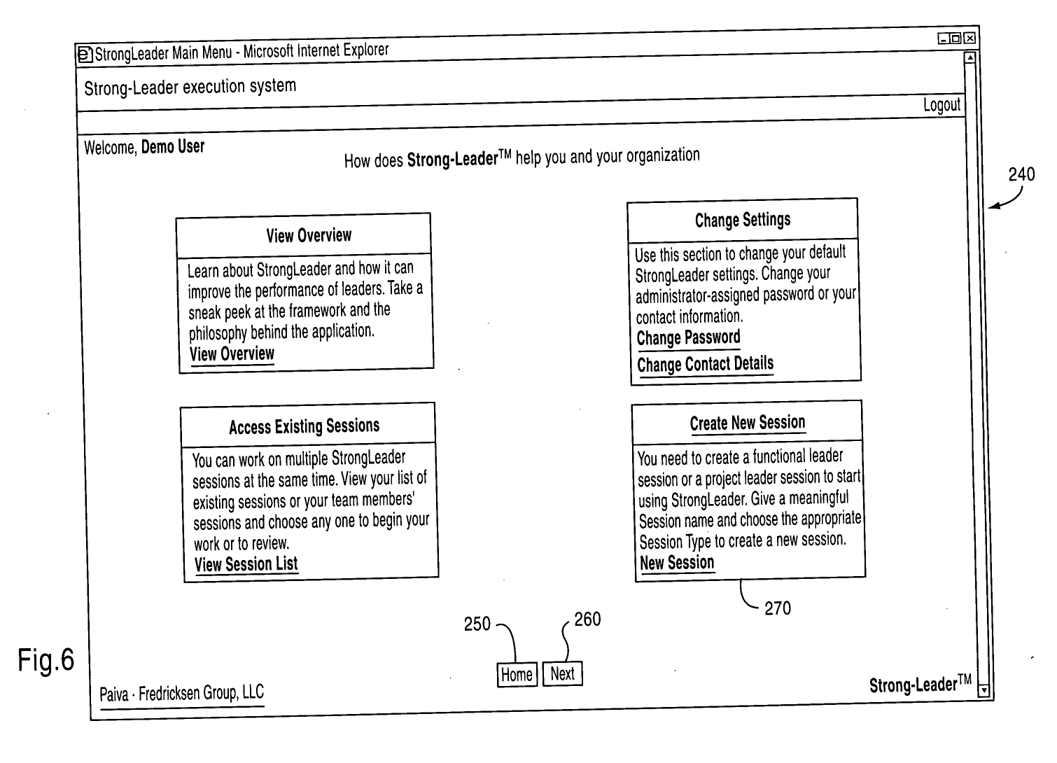

Referring to FIG. 6, following login or other appropriate security authorization, the main page is identified as screen 240 and provides a variety of options to the user, such as 1) addressing administrative functions (e.g., changing the user's login or password); 2) viewing a demonstration or overview of the software application; 3) starting a new session; 4) entering an existing session; or 5) exiting the system. At the bottom of the screen 240 as shown in FIG. 6 are navigation buttons 250-260 for navigating from screen to screen. When the button 250 labeled “Home” is selected, the main page is redisplayed. When the button 260 labeled “Next” is selected, the next screen in order is displayed.

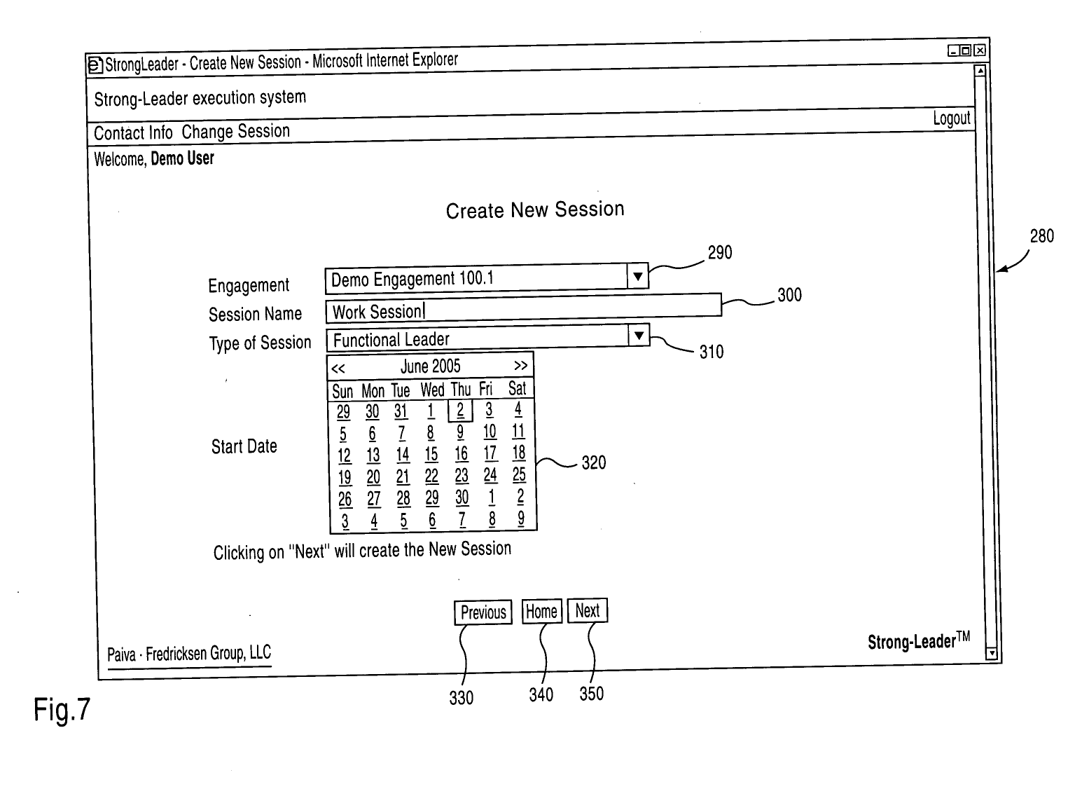

A series of exemplary access events will now be discussed in more detail, in accordance with a business idea implementation embodiment of the present invention. Referring to FIG. 6, the user first selects New Session button 270 to begin a new session. Referring to FIG. 7, the user must then complete numerous fields, such as via screen 280. A first field 290 is entitled “Engagement”. For example, an engagement is a client's individual consulting project in which the business system and method of the present invention is being implemented. It should be noted that multiple engagements could be in place for a single client. Further, in one embodiment of the present invention, the “Engagement” field includes a pulldown menu from which a particular engagement is selectable from a plurality of listed engagements. The user inputs or selects an engagement name corresponding to a particular project for which work is to be performed.

Next, the user inputs a name for the new session in a field 300 labeled “Session Name.” The session name is an identifier used to distinguish and identify the newly created session from other previously created sessions. The activity occurring during the newly created session is stored under the session name so that the information can be easily and orderly recalled at a later time.

Also, the user designates the type of session to be created in the Type of Session field 310. In one variation of the present invention, two categories labeled “Functional Leader” and “Project Leader” are selectable. Next, the user selects the date on which the session is created in the “Start Date” field 320.

Near the bottom of the screen are one or more navigation buttons. A first button 330 labeled “Previous” returns the user to the screen previously displayed. A second button 340 labeled “Home” returns the user to the main page, and a button 350 labeled “Next” advances the user to the next screen. The user selects the Next button 350 to create a new session.

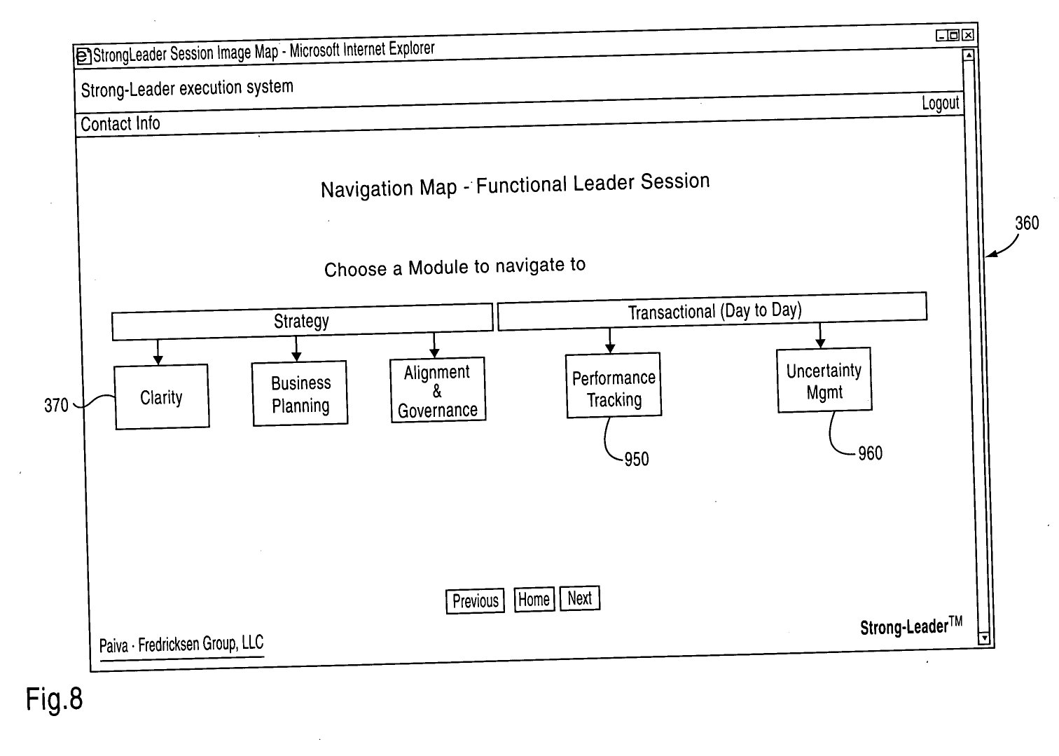

Various additional features of the particular implementation directed to the business idea implementation embodiment of the present invention as shown in FIG. 8 and those following, will now be described in further detail.

Functional Leader Session

When the user creates a new functional leader session, a new screen 360 appears, presenting the user with a new set of selectable items. As shown in FIG. 8, the user can select from different categories of execution modules, such as Strategy and Transactional. Contained within each category is at least one execution module that provides specific lessons and presentations, as well as tools to teach, execute, and reinforce business skills. The first category, entitled “Strategy,” includes, for example, execution modules entitled “Clarity,” “Business Planning,” and “Alignment and Governance.” The second category, entitled “Transactional,” includes a plurality of execution modules, such as Performance Tracking and Uncertainty Management. After a new session is started, the user begins by selecting an execution module, such as the Clarity execution module, although it is within the scope of the present invention that the user may begin with any execution module.

Strategy Category

In the Strategy category, the user completes a series of execution modules and submodules to formulate and develop a plan to improve performance of a department or group over which the employee has authority or is involved (also referred to as the employee's department). The various execution modules and associated submodules are explained below according to one embodiment of the present invention.

One purpose of the Clarity execution module is to assist the employee in focusing the business idea, such as the purpose of the employee's position and the employee's department. As the user progresses through each screen of the submodule, the information inputted is stored for later use. The Clarity execution module is completed by performing the following actions:

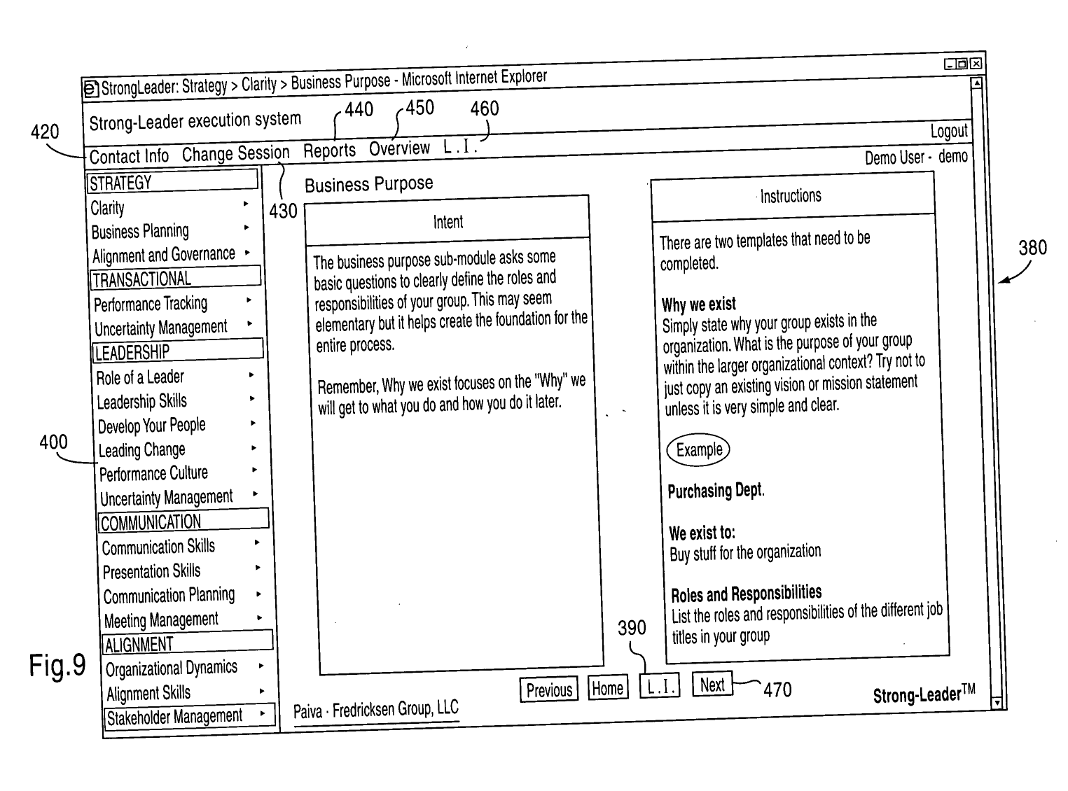

1. The user selects the “Clarity” button 370 in FIG. 8, causing a first screen 380 of the Business Purpose submodule to appear, as shown in FIG. 9. The first screen 380 includes information on the purpose or intent of the information required for and directions on how to complete the Business Purpose submodule.

Screen 380 also includes a button 390 labeled “L.I.” Selecting the L.I. button 390 advances the user directly to a Leadership Integrator, which contains information to aid the employee in becoming a more effective leader, as discussed in more detail below. Alternatively, when the user is within the Leadership Integrator, a button labeled “E.M.” (not shown) appears in place of the L.I. button 390. The E.M. button allows the user to jump from the Leadership Integrator to the first screen of the execution module in which the user is engaged.

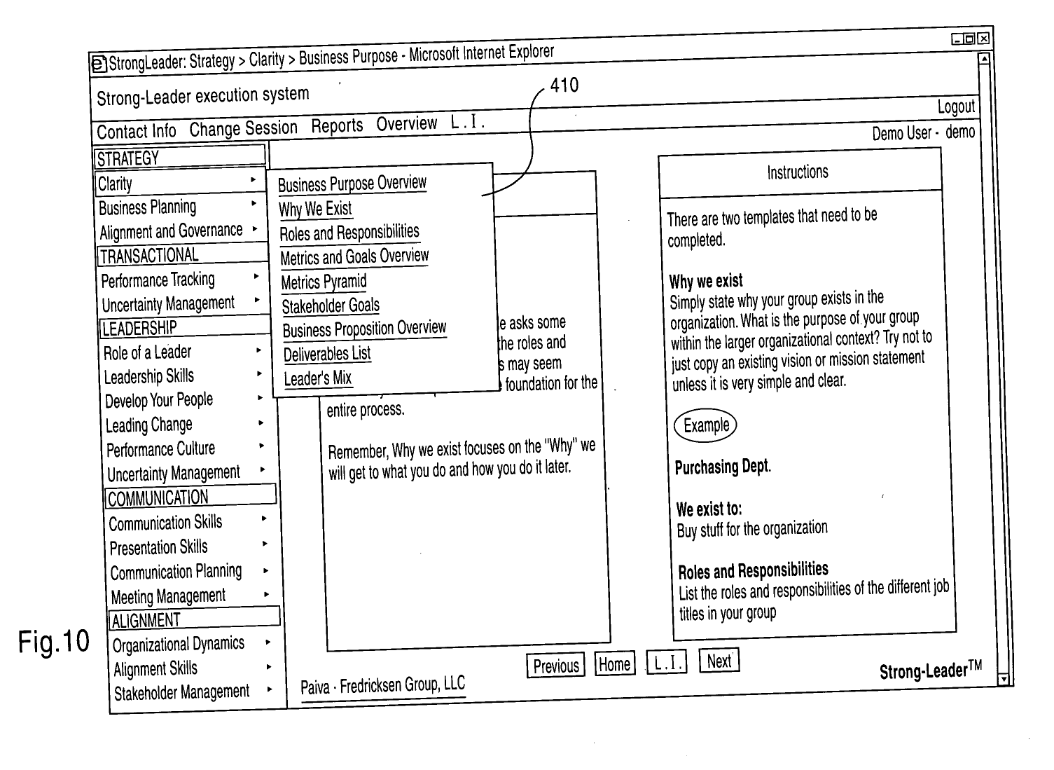

The left side of the screen, as shown in FIG. 9, contains an Image Map 400 having a set of buttons for quickly navigating between the different execution modules and submodules. The Image Map 400 appears throughout the software application while the user completes the various execution modules and submodules. In one embodiment of the present invention, when a cursor is placed over the name of an execution module, a side menu 410 appears, as shown in FIG. 10. The side menu 410 contains direct links to particular submodules of each execution module. When a direct link is selected, the first screen of the particular submodule is displayed.

Referring again to FIG. 9, in one embodiment of the present invention, an additional group of navigation buttons 420-460 appears in a portion of the screen. The buttons 420-460 are respectively labeled as “Contact Info,” “Change Session,” “Reports,” “Overview,” and “L.I.” The L.I. button 460 appears when the user is completing an execution module. However, when the user is completing a Leadership Integrator, the L.I. button 460 is replaced with a button labeled “E.M.” (not shown). The L.I. and E.M. buttons provided on the screen 380 operate similarly to the corresponding L.I. and E.M. buttons provided on the screen 380 of FIG. 9, as described above.

When selected, the “Contact Info” button 420, as shown in FIG. 9, displays the coach's contact information; the “Change Session” button 430 allows the user to change to a new or different session when selected; the “Reports” button 440 allows the user to view the reports generated by the current session when selected; and the “Overview” button 450 provides general information about and capabilities of the software application.

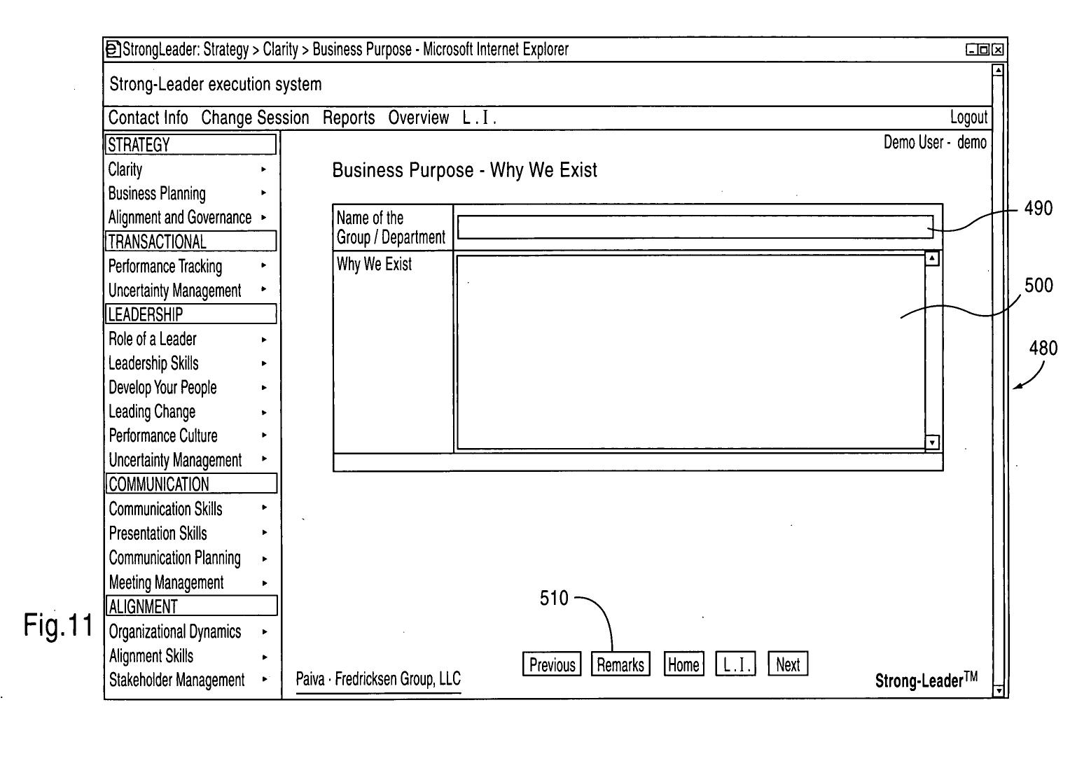

2. After reading the information, the user selects Next button 470, as shown in FIG. 9, and the screen 480 shown in FIG. 11 appears.

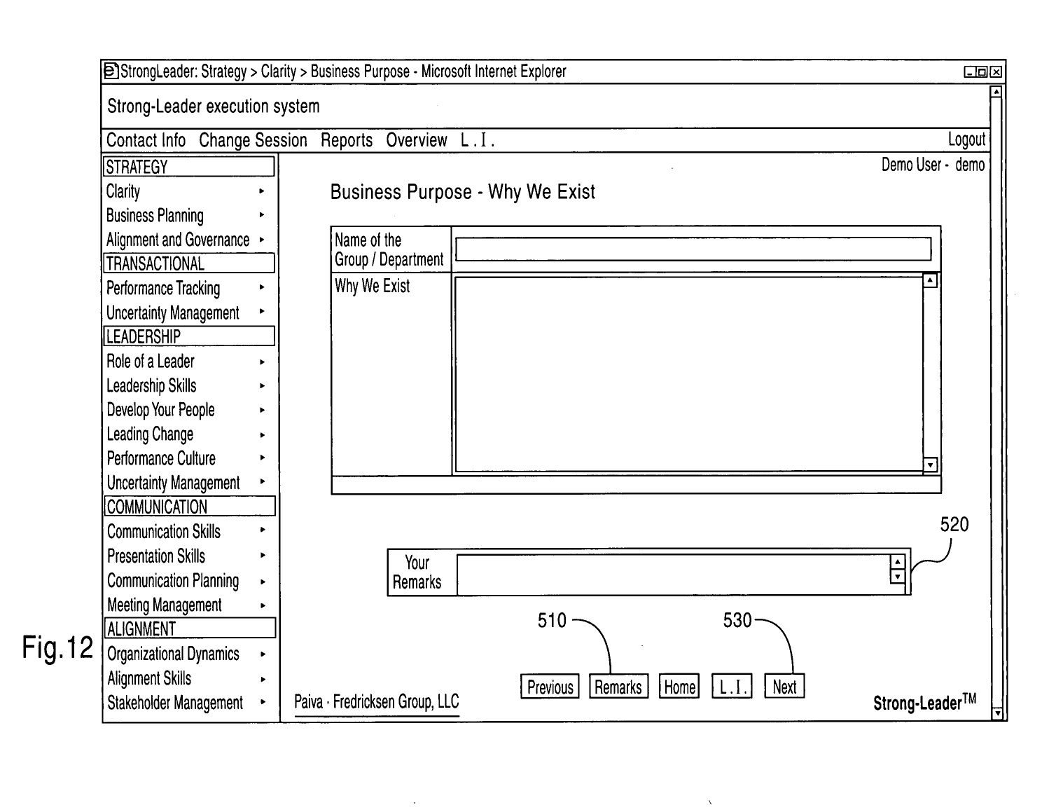

3. Referring to FIG. 11, screen 480 contains two fields. In a first field 490 labeled “Name of the Group/Department”, the user inputs the name of the employee's department. In a second field 500 labeled “Why We Exist,” the user inputs what the employee believes the purpose and/or function of the employee's department to be. In one portion of the screen, an additional navigation button 510 exists, entitled “Remarks.” As illustrated in FIG. 12, when the Remarks button 510 is selected, a new field 520 appears, in which the employee or coach may input remarks, such as remarks about the information being requested.

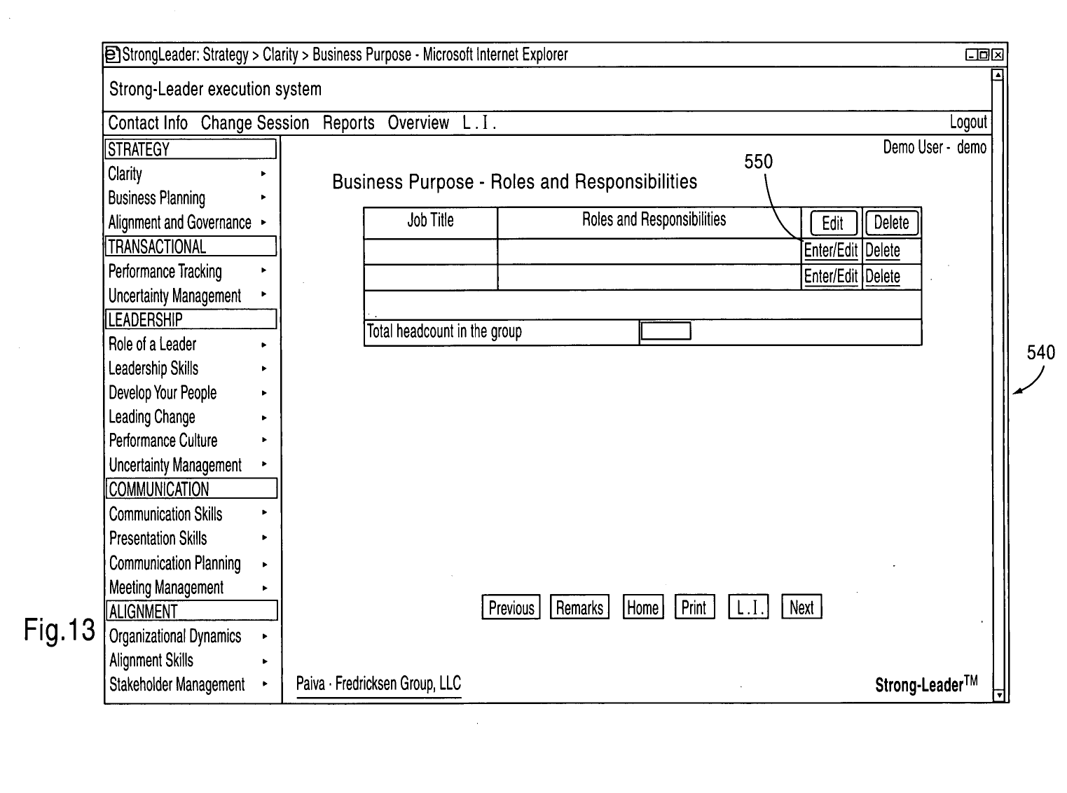

Once both fields 490 and 500 are completed, as shown in FIG. 11, the user selects the Next button 530 near the bottom of the screen 480, and the screen 540 of FIG. 13 then appears.

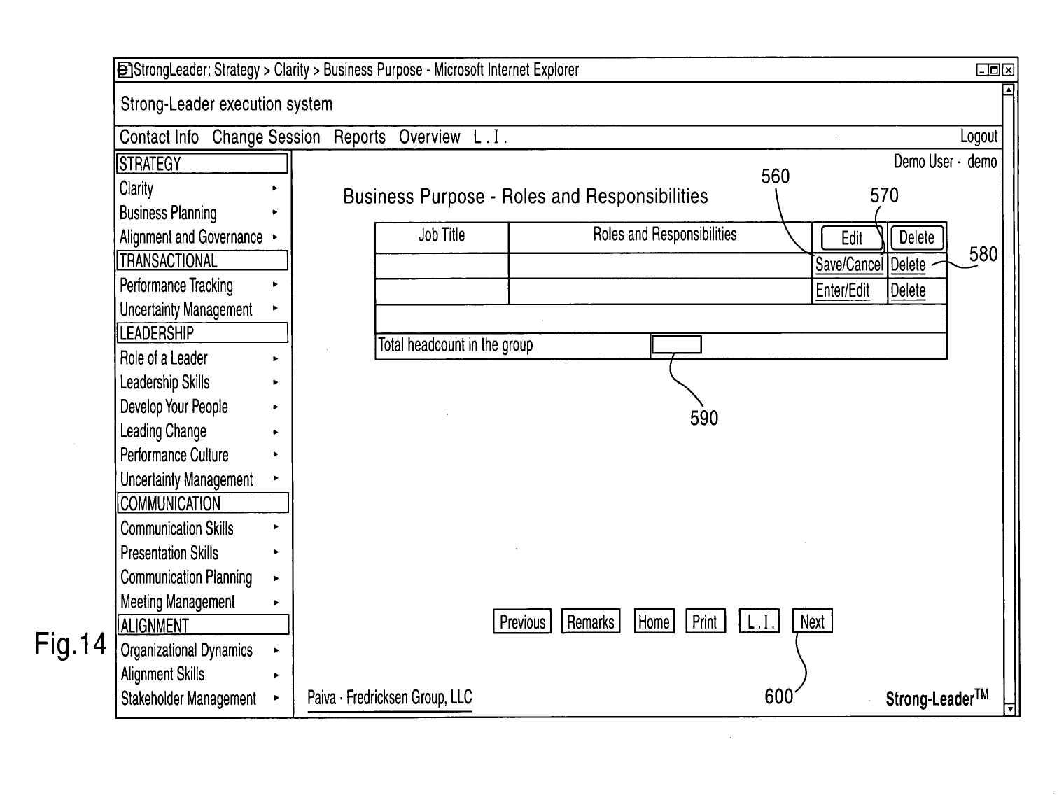

4. On screen 540, as shown in FIG. 13 the user selects the Enter/Edit button 550 and inputs the job titles of the positions within the employee's department, as well as the roles and responsibilities associated with each job title. After the information has been inputted, the user saves the information using the Save button 560 (shown in FIG. 14, which appears once the Enter/Edit button 550 is selected. Alternately, the user selects the Cancel button 570 to cancel the information entered. If a row of information is no longer needed, the user can delete an entire row by selecting the Delete button 580. Enter/Edit, Save, Cancel, and Delete buttons, similar to those described above, are used throughout the software application and operate in a corresponding manner.

The user then inputs the total number of employees within the employee's department in a field 590 labeled “Total Headcount in the Group” near the bottom of the screen. The user then selects a Next button 600 near the bottom of the screen 540, after which the screen 610 of FIG. 13 appears.

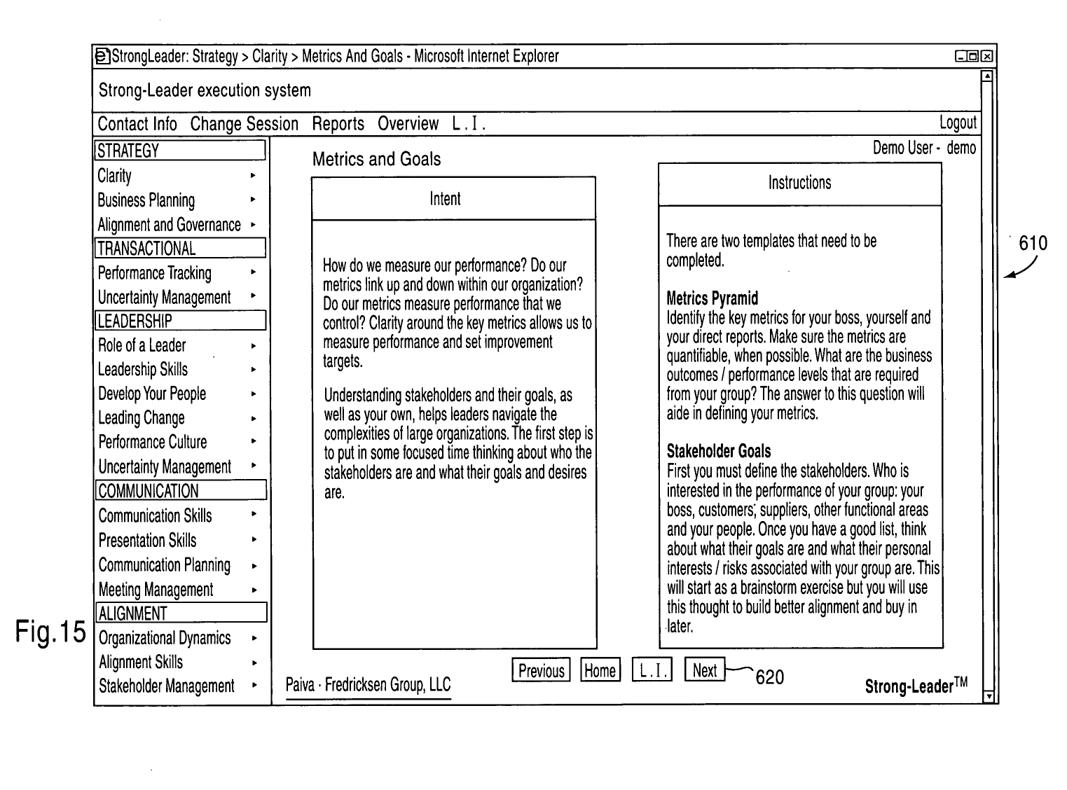

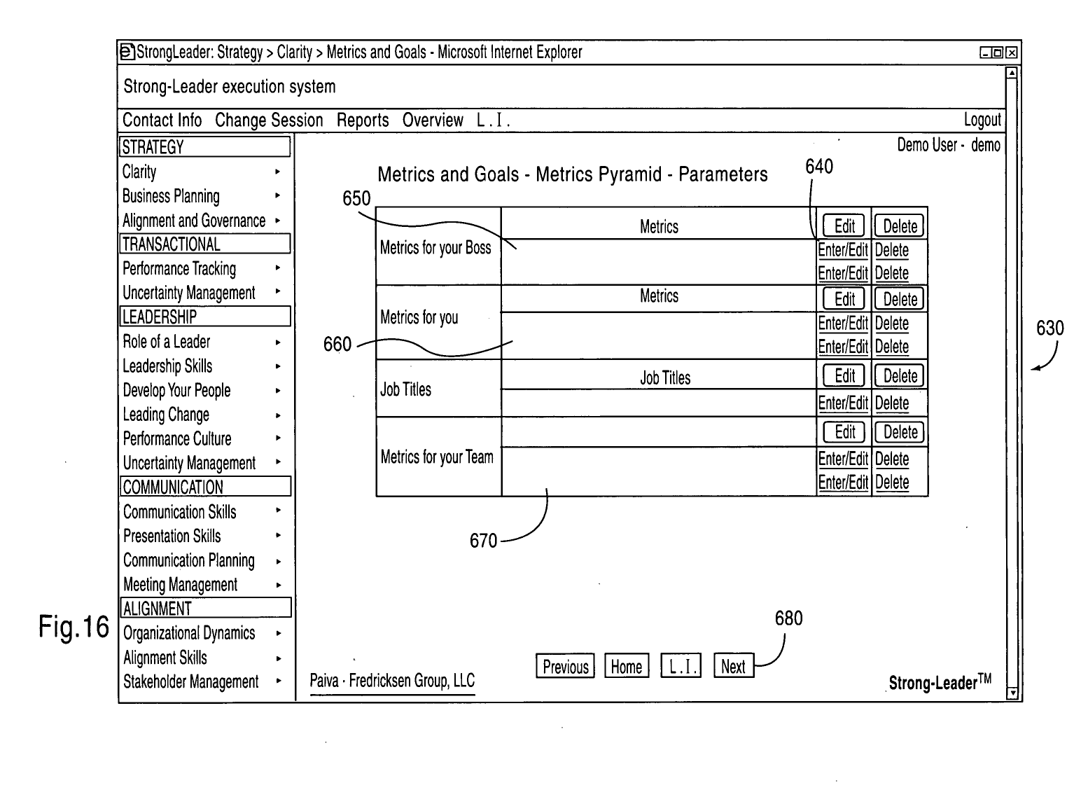

5. Referring to FIG. 15, a next screen 610 begins the Metrics and Goals submodule of the Clarity execution module. Screen 610 of the Metrics and Goals submodule is similar to the first screen 380 (FIG. 9) of the Business Purpose submodule, wherein the first screen of the Metrics and Goals submodule includes information regarding one or more purposes of the submodule, as well as how to complete the submodule. The Metrics and Goals submodule aids the employee in identifying the performance criteria that the employee believes are used to measure the employee's own performance, the performance of each of the employees in the employee's department, and the employee's boss's performance. When the user has read the provided information, the Next button 620 is selected, and the next screen 630, as shown in FIG. 16, appears.

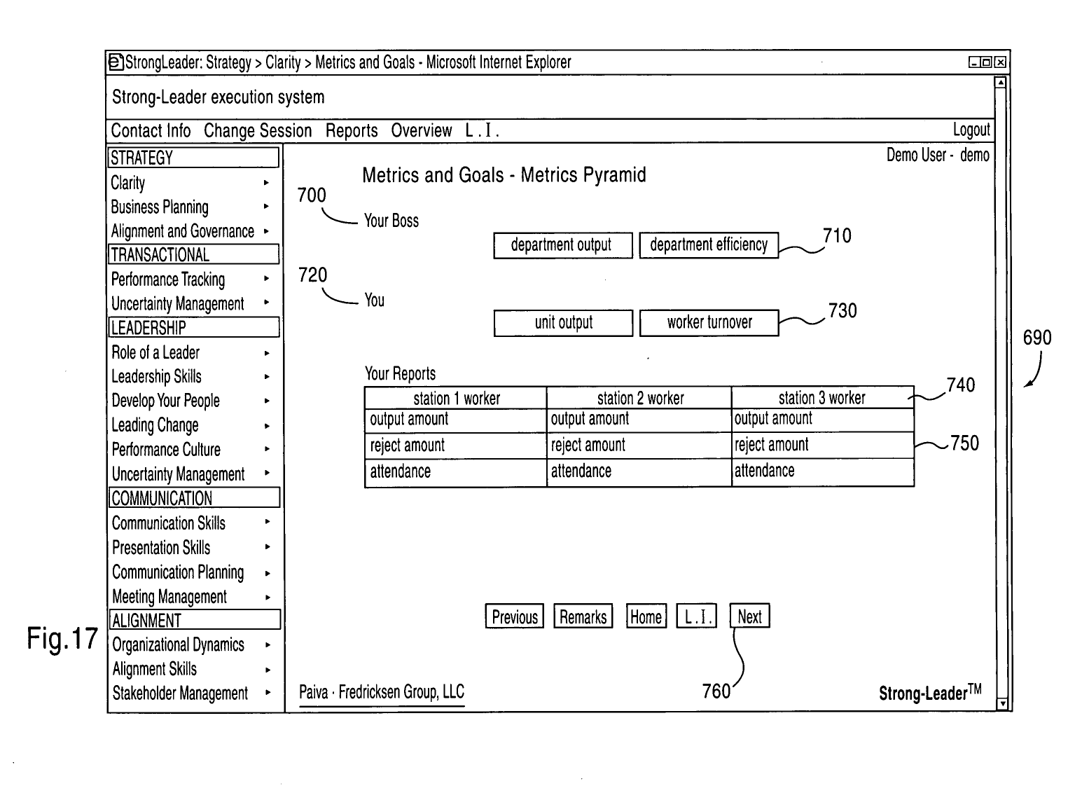

6. In screen 630, the employee inputs the metrics for the employee's boss, the employee, and for each position within the employee's department by selecting the Edit/Enter button 640 next to the corresponding fields 650-670 labeled “Metrics for your Boss,” “Metrics for You,” and “Metrics for Your Team,” respectively. Examples of metrics include, for example, the amount of output of the employee's department, the efficiency of the employee's department, and the profitability of the employee's department. Once each metric is inputted, the Save button (not shown) is selected to save the inputted information. The user then selects a Next button 680, and the following screen 690, as shown in FIG. 17, appears.

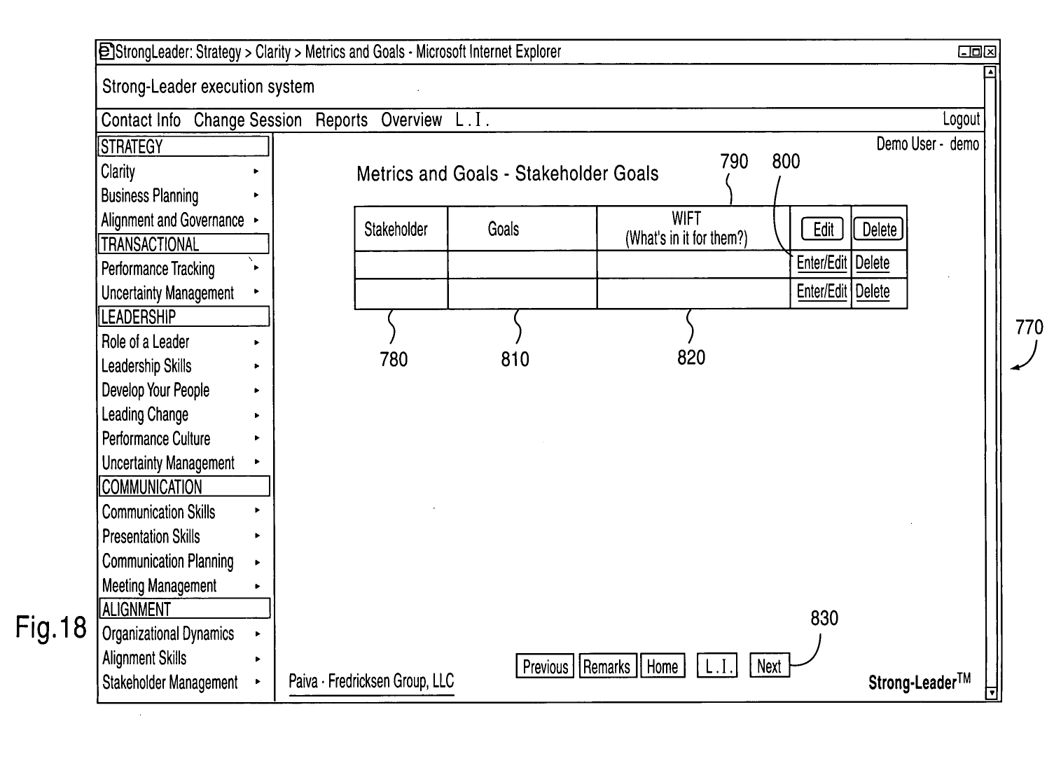

7. In FIG. 17, a new screen 690, entitled “Metrics Pyramid,” displays a hierarchical representation of the information inputted in the previous screens. The employee's boss is displayed at an upper position 700 of the hierarchy, as shown in FIG. 17, and the metric or metrics for measuring the boss's performance are displayed immediately below at position 710, as shown in FIG. 17. Next, the employee is listed below the boss's metric or metrics at position 720, with the employee's metrics listed immediately therebelow at position 730, as shown in FIG. 17. Finally, the job titles of the positions within the employee's department are presented near a bottom position 740 of the screen 690, as shown in FIG. 17. The metrics for each position are listed just below the corresponding job title at a position 750, as shown in FIG. 17. Once the employee and coach have reviewed the information listed, a Next button 760 is selected, and the screen 770 of FIG. 18 appears.

8. FIG. 18 illustrates a screen 770, wherein the user inputs the names of any stakeholder in a first column 780 of table 790 using the Enter/Edit buttons 800. Stakeholders are persons or entities who have an interest or stake in the work quality and output of the employee or employee's department. Stakeholders include, for example, the client's shareholders, managers, customers, suppliers, and other employees within the business.

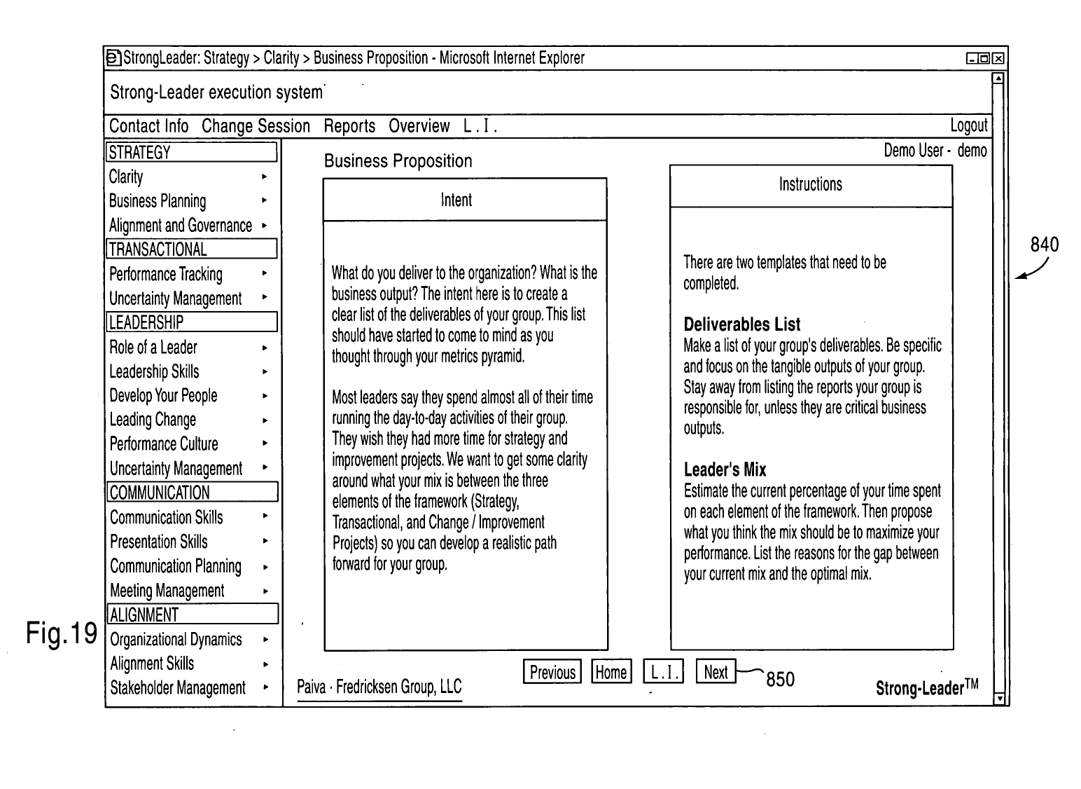

In a second column 810 of table 790, the employee inputs what the employee believes to be the goals of each stakeholder. In the third column 820, the employee inputs what the employee believes to be the stakeholders' interests or stakes affected by the employee's performance. A Next button 830 is then selected, and the screen 840 of FIG. 19 appears.

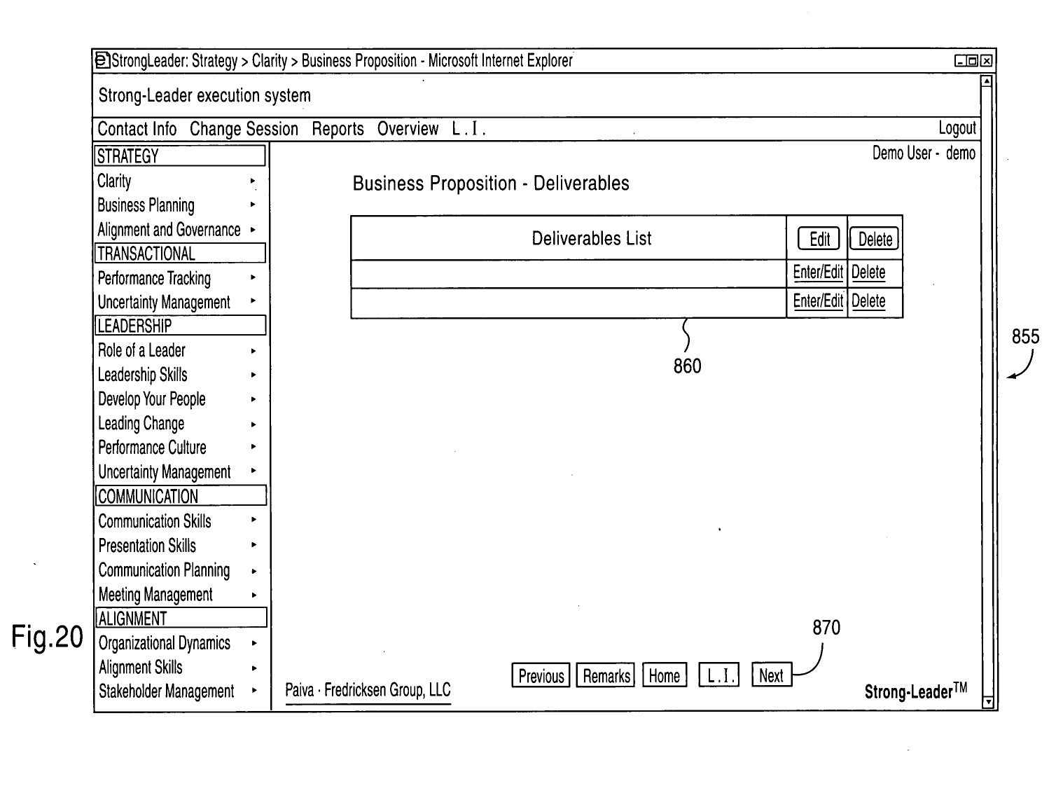

9. Screen 840, illustrated In FIG. 19, begins a new submodule entitled “Business Proposition.” A purpose of the Business Proposition submodule is to aid the employee in determining what the employee's department output is. The screen 840 includes the directions for entering information required for the submodule, as well as a purpose or intent for soliciting such information. Once the employee has read the provided information, a Next button 850 is selected, and the following screen 855 of FIG. 20 appears.

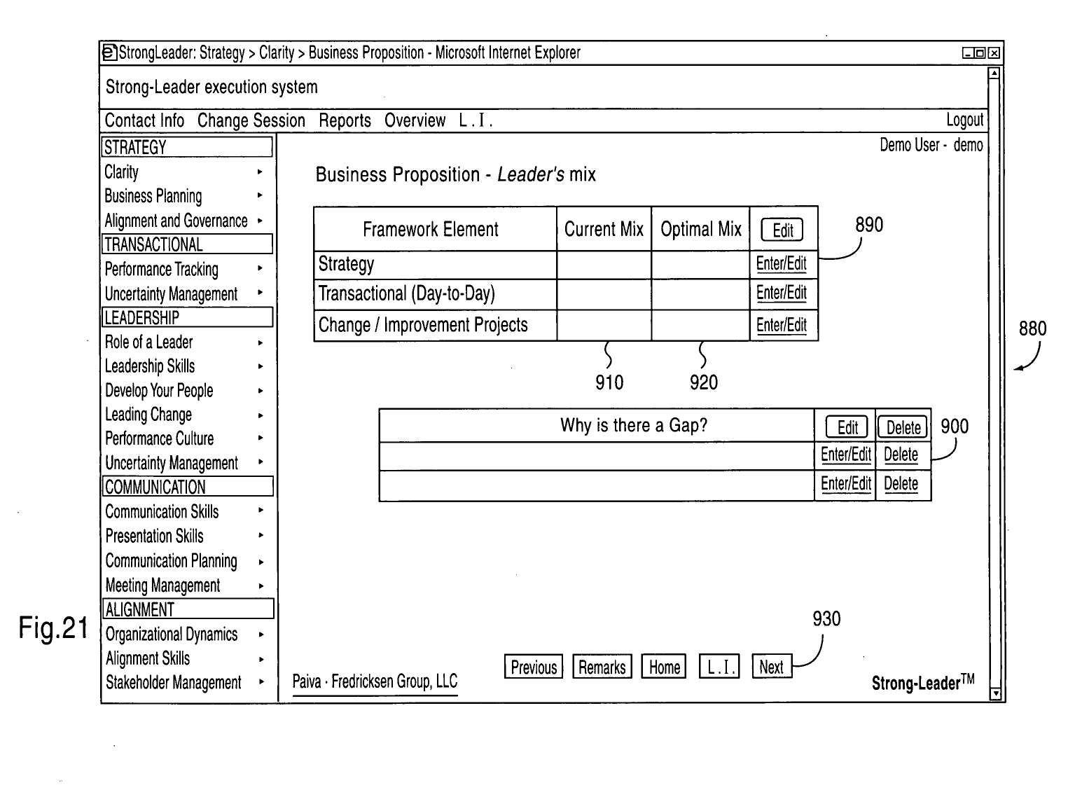

10. On screen 855 shown in FIG. 20, the employee inputs a list of the deliverables that are output by the employee's department, such as critical business reports or production units, in table 860. After entering all of the deliverables, a Next button 870 is selected, and screen 880 of FIG. 21 appears.

11. Referring to FIG. 21, screen 880, entitled the Leader's Mix, has two tables 890 and 900. In a first column 910 of the first table 890, the user inputs the current percentage of time expended on different job-related activities, such as strategy, transactional or day-to-day activities, and change/improvement projects. In a second column 920, the user inputs the percentage of time the user would prefer to spend on the different job-related activities. In the second table 900, the user inputs the disparity between the actual percentage of time spent on a business activity and the preferred amount of time. Once both tables are complete, the user selects a Next button 930.

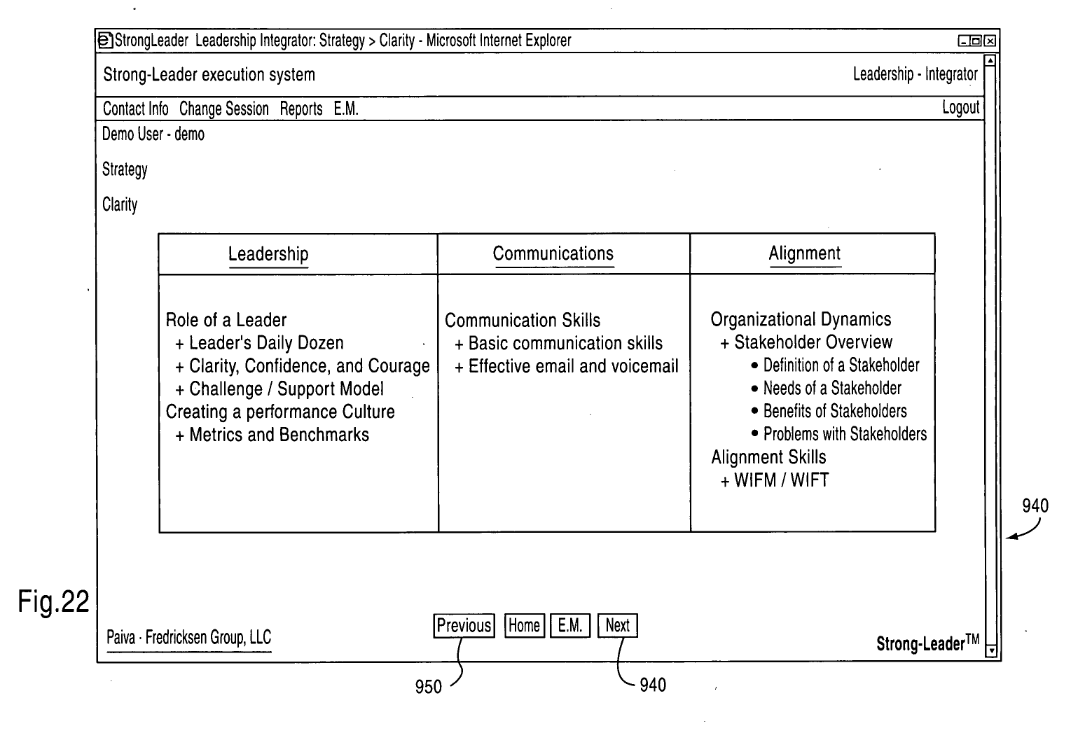

After completion of the Business Proposition submodule, the system advances to the Leadership Integrator for the Clarity execution module, a first screen 940 of which is shown in FIG. 22. A Leadership Integrator is provided at the conclusion of each execution module and includes execution modules and submodules from the Leadership, Communications, and Alignment categories. Moreover, a Leadership Integrator following a given execution modules is tailored with execution modules and submodules from the Leadership, Communication, and Alignment categories that are particularly applicable to the given execution module. Leadership Integrators provide information and suggestions for improving the employee's leadership capability in each of the categories mentioned above in the context of a particular execution module. Particularly, the Leadership Integrator for the Clarity execution module provides soft skills to aid the employee in accomplishing the objectives of the Clarity execution module more effectively. For example, the Leadership Integrator provides information to the employee on how to better lead the employee's department; how to communicate more effectively both with the department members and to other employees; and how to align interests of the department members with the interests of the client to improve both the employee's department performance and the client's performance overall.

Referring to FIG. 22, the user can navigate through the “Leadership Integrator” by using the Next and Previous buttons 940 and 950, respectively. Once the user has advanced through the entire Clarity execution module, the user is ready to begin the Business Planning execution module. However, the user is not limited to progressing through the execution modules and submodules in any particular order. By using the Image Map 400 (shown in FIG. 9), the user can go directly to any execution module or submodule at any time within a session.

The Business Planning execution module has a similar arrangement to the Clarity execution module and contains one or more screens in which the user inputs information relating to the performance level of the employee's department. The user completes the Business Planning execution module in a manner similar to that in which the Clarity execution module was completed.

In one embodiment of the present invention, a purpose of the Business Planning execution module is to assist the employee in understanding and improving the operating level of the employee's department. As the user progresses through each screen of the submodule, the information inputted is stored for later use. Next, the user may begin the Business Planning execution module. The Business Planning execution module contains various submodules, such as Vision and Strategy, Planning, and Roadmap.

In the Vision and Strategy submodule, the user enters information relating to where the employee believes the department is performing, where the employee would like it to be performing, the metrics useful in measuring whether the employee's department is meeting performance targets, and the duration of time for the employee's department to attain the desired performance level or goal. The user also develops and outlines an operational process of how the employee's department works. For example, the user enters the inputs of the employee's department, the department's workflow, and the department's outputs.

Next, the user advances to the Planning submodule. In the Planning submodule, the user formulates and inputs activities or projects that will deliver the performance level described above in the Vision and Strategy submodule, as well as an explanation of how each project or activity will enable the employee's department to achieve its performance goal. Once the projects and activities have been defined, the employee and coach then decide which of the employees in the employee's department will be responsible for completing each project. Additionally, the employee and coach decide which department employee will lead each project and why.

In the Roadmap submodule, the user creates a plan to improve the performance of the employee's department from a level at which it presently operates to a desired level. In one embodiment, the employee identifies an expected change in work volume required from the employee's department and any expected changes in, for example, budget and populace of the department that corresponds with the desired performance level. Next, the employee summarizes how a proposed business plan will impact the department's employees, processes employed in the department, and any technology used within the department. Additionally, by engaging in the Roadmap submodule, the employee is able to identify and manage any risk associated with a proposed business plan for the department.

Once the roadmap submodule of the Business Planning execution module has been completed, the Leadership Integrator associated with the Business Planning execution module begins and performs a similar function as the Leadership Integrator following the Clarity execution module. That is, the Leadership Integrator following the Business Planning execution module aids the employee in implementing the different submodules of the Business Planning execution module within the employee's department by offering tips and suggestions to improve leadership, communicate more effectively, and aligning the interests of the department's employees with those of the business.

After viewing the Leadership Integrator for the Business Planning execution module, the user is advanced to the Alignment and Governance execution module. A purpose of the Alignment and Governance execution module is to identify and define key success factors, e.g., milestones, changes, and actions that must take place if the employee's department is to improve performance. Additionally, the user identifies potentialities related to stakeholders that may prevent the employee's department from meeting performance goals. Further, the Alignment and Governance execution module include a risk assessment submodule, wherein the user must identify risks and other potential problems that may prevent the employee's department from realizing performance improvements.

The Alignment and Governance execution module includes one or more submodules, which are completed in a similar manner described above, by inputting requested information into various fields contained in one or more screens.

Transaction Category

The Transaction category of execution modules provides progress tracking capabilities to aid the employee in achieving desired performance targets and includes one or more submodules, such as Performance Tracking and Uncertainty Management.

According to one embodiment of the present invention, execution modules in the Transaction category are completed in a similar manner to that described above, wherein the user progresses through a series of screens, learning one or more purposes of each submodule and inputting the required information. Thereafter, the information is stored for later use.

The user begins the Transactional category by selecting an execution module using corresponding buttons 950-960 located on screen 360, as shown in FIG. 8. Alternately, the user may advance to an execution module, for example, using the Image Map 400, as illustrated in FIG. 9.

The Performance Tracking execution module comprises one or more submodules, such as Metrics Tracking, People Tracking, and Process Tracking. In one embodiment of the present invention, the Performance Tracking execution module provides one or more templates that convert yearly goals and objectives into a weekly activities list. These lists enable the employee to structure, focus, and track activities to ensure performance targets are achieved. The user first inputs each type or category of work that the employee's department performs. Then, the user inputs the yearly deliverables or objectives associated with each category of work, as well as the yearly quarter in which each objective or deliverables associated with each work category is due.

The user then inputs the different business processes used by the employee's department to carry out each of the work categories, and how well each process is defined, documented, and automated. Further, the user inputs the effectiveness of each process, as well as the reasons for each process's effectiveness.

The user is also prompted to enter metrics for measuring the performance level of the employee's department. The metrics are measurements to aid the user in understanding just how well or poorly the department is performing over the course of time. Based on this information, the employee is able to make necessary changes to increase performance, if necessary. In one embodiment of the present invention, the user also inputs how often each metric should be measured, the data source for the information and how to ensure the integrity of the data. The employee can then use the metric data to improve implementation of the business idea to meet previously established goals.

In a next step, the user enters the actual performance for each metric at regular intervals over a period of time, such as a year. For each metric that has a performance gap, that is, a gap between where a performance metric should be and where the performance metric actually is, the user describes the reason or reasons for the gap, and an action plan to close the gap. Next, the user compares the department's overall performance in each work category against the identified yearly goals and objectives and, with the aid of the coach, identifies any action plans for improving any goal or objective that is not being achieved.

The Performance Tracking submodule may also include a people tracking component, which is used to measure the employee's performance, the performance of each employee within the employee's department, and any stakeholders previously identified in the Strategy execution module. By measuring the performance over time, the employee can determine whether the department is meeting its maximum performance goals, at least partially defined in the Clarity submodule of the Strategy execution module. For example, the employee identifies each employee within the department, a corresponding focus, developmental status, and whether any coaching is required. Next the employee and coach analyze the employee's own performance by classifying how the employee's time is spent in comparison to the desired classification previously entered in the Leader's Mix. Finally, the user determines whether any stakeholders previously identified are aligned with the objectives of the client. If not, the employee and coach develop a plan to bring the stakeholders into alignment. Therefore, by tracking performance over time, the employee can use the information to make adjustments within the department to improve the department's performance and meet goals previously established.

After completing the Performance Tracking submodule and accompanying Leadership Integrator, the user moves on to the Uncertainty Management submodule. A purpose of the Uncertainty Management submodule, for example, is to develop mitigation strategy or contingency plans for each risk identified in the Alignment and Governance submodule of the Strategy execution module, identify any issue affecting the performance of the employee's department, and develop a process for maintaining the control and direction of the employee's department. The user completes the Uncertainty Management submodule in a manner similar to the submodules previously described, such as by inputting requested information into fields provided on one or more screens. Thereafter, the user begins the Leadership Integrator associated with the Uncertainty Management submodule.

Project Leader Session

A user may also complete a Project Leader session. The project leader session is used, for example, to improve management skills in relation to a finite or particular goal. The user begins a project leader session in a manner similar to the start of a functional leader session. Again referring to FIG. 6, the user selects the New Session button 270. On the following screen 280 shown in FIG. 7, the user then selects an appropriate Engagement from the Engagement field 290, a new session name from the Session Name field 300, the “project leader” selection from the Type of Session field 310, and a session start date from the Start Date field 320. The user then selects the Next button 350.

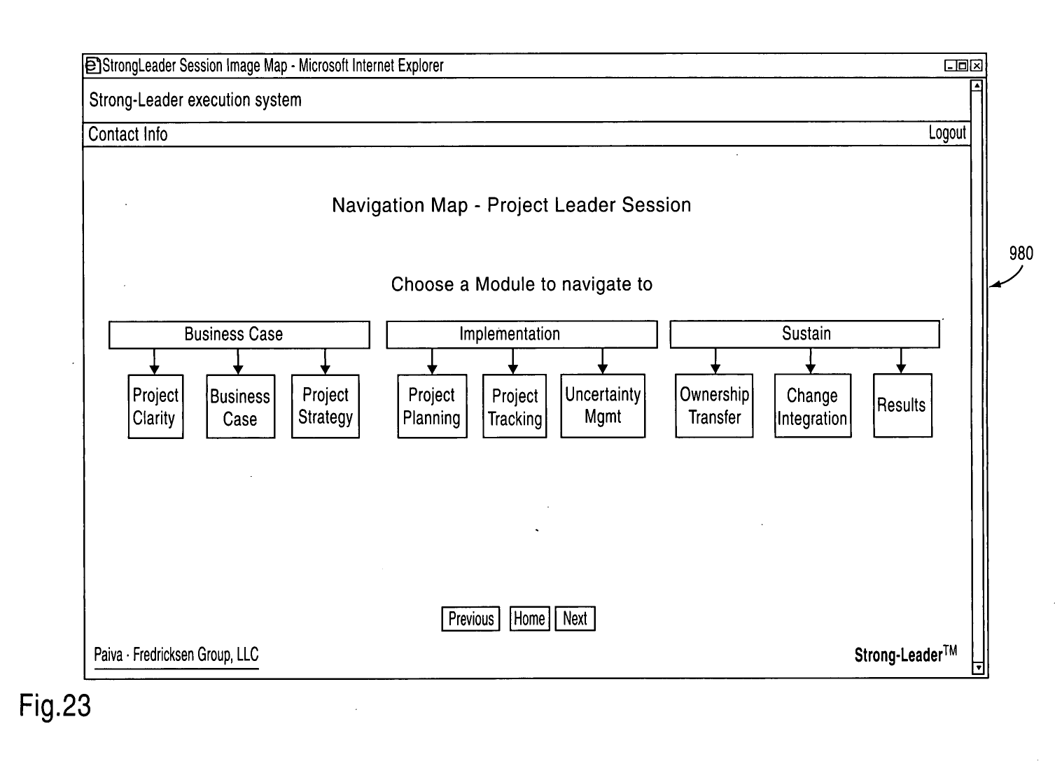

Once the user has created a new Project Leader session, a new screen 980 appears presenting the user with a new set of selectable items, as shown in FIG. 23. The user can select from different categories of execution modules, such as Business Case, Implementation, and Sustain. Contained within each category is at least one execution module that provides specific lessons and presentations, as well as tools to teach, execute, and reinforce business skills. The first category entitled “Business Case” includes, for example, execution modules entitled “Project Clarity,” “Business Case,” and “Project Strategy.” The second category entitled “Implementation” includes a plurality of execution modules, such as Project Planning, Project Tracking, and Uncertainty Management. The third category entitled “Sustain” includes execution modules, such as Ownership Transfer, Change Integration, and Results. One or more submodules are included within each execution module. Alternatively, the Project Leader session may contain additional or fewer execution modules than those enumerated.

Business Case Category

After a new session is started, the user begins by selecting an execution module, for example, the Project Clarity execution module, although it is within the scope of the present invention that the user may begin with any execution module. The execution modules and submodules are completed in a manner similar to the manner described above with respect to the Functional Leader session.

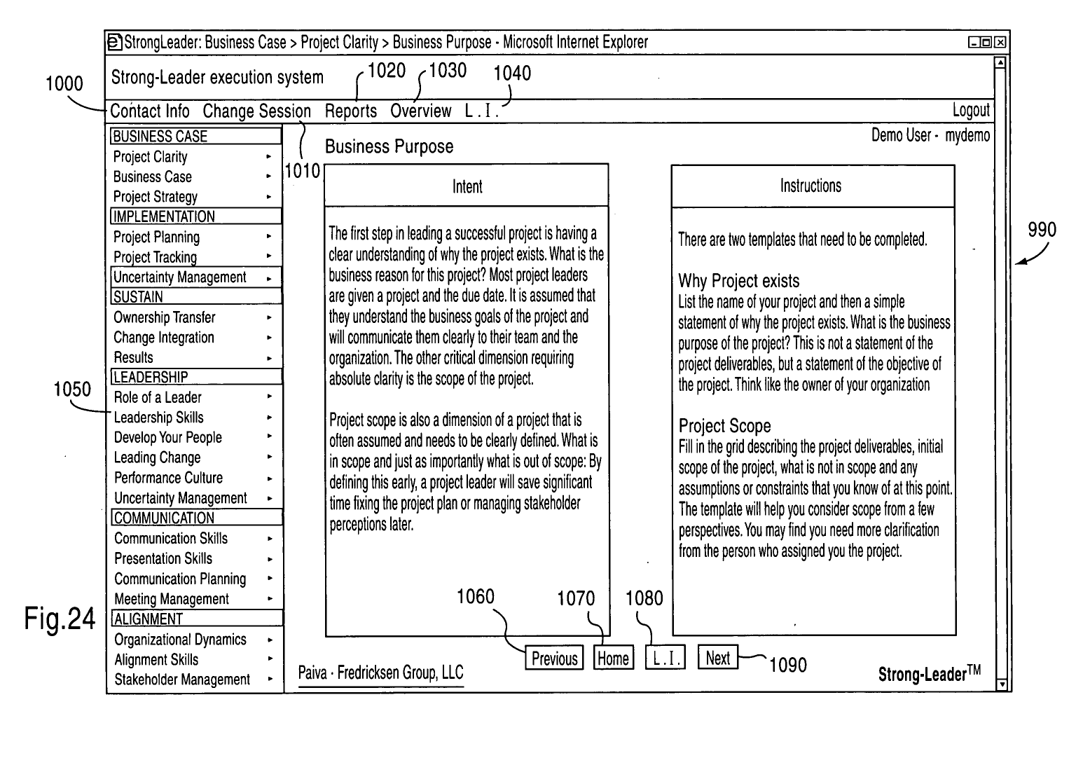

Referring to FIG. 24, screen 990 is arranged similarly to the screens used in the Function Leader session for completing the execution modules contained therein. Navigation buttons 1000-1040, respectively entitled “Contact Info,” “Change Session,” “Reports,” “Overview,” and “L.I.,” which are provided in one portion of the screen 990, are used for navigating between different screens. Also, as described above, the L.I. button 1040 is replaced by a button entitled “E.M.” (not shown) when the user is completing a Leadership Integrator following an execution module. Each button operates similarly to the correspondingly named button described above.

Again referring to FIG. 24, an Image Map 1050 also appears on the screen 990 and operates similarly to the Image Map 400 described above. Also illustrated in FIG. 24 are one or more navigation buttons 1060-1090 located in one portion of the screen 990. The navigation buttons 1060-1090 operate similarly to the corresponding navigation buttons 330, 340, 390, and 470 described above.

The Project Clarity execution module is similar to the Clarity execution module contained within the Functional Leader session. In the Project Clarity submodule, the user inputs general project information, such as the name of the project, why the project exists (e.g., business purpose of the project), the scope of the project, specific goals and benefits the project will deliver, any stakeholders of the project, and how the stakeholders expect to benefit from the project. Additionally, the user inputs the metrics used to measure the progress of the project, including performance data, such as output, efficiency, and quality levels. Further, the Project Clarity execution module may include submodules that prompt the user to input information regarding team members responsible for executing the project, each team member's role and responsibilities of the project, person or persons involved in making project decisions, and a workplan. According to one embodiment of the present invention, the workplan details important events related to the project and the start and end dates of each event.

A Leadership Integrator follows each execution module, and serves a similar function as the Leadership Integrators described in relation to the execution modules in a Functional Leader session. After reviewing the Leadership Integrator, the user continues with an execution module entitled “Business case,” although it is within the scope of the present invention to continue with any execution module.

During completion of the submodules included in the Business Case execution module, the user inputs information, such as any benefit each stakeholder of the project will receive, the actions each stakeholder will take in order to realize those benefits, and any changes stakeholders must make in order to realize these benefits. Changes stakeholders must make include, but are not limited to, changes in personnel, technology, or business processes. Understanding the stakeholders' status allows the project leader to make adjustments to ensure the stakeholders continue supporting the project. Further, the Business Case execution module prompts the user to identify overall benefits of the project and the costs associated therewith, in order to create a cost-benefit analysis. This allows the project leader to make a preliminary judgment about the necessity and priority of the project. The Business Case execution module concludes with a Leadership Integrator, similar to the Leadership Integrators described above.

Once the user has advanced through the entire Business Case execution module, the user is ready to begin the Project Strategy execution module.

One purpose of the Project Strategy execution module is to develop a plan for implementing the project. Particularly, the Project Strategy execution module requires the user to identify key activities (also interchangeably referred to herein as “key workstreams”) whose success is critical to the overall project's success. Major phases of the project and associated timelines for completion of those phases are also inputted. Additionally, the user inputs any foreseeable risks to the project; metrics for measuring the progress, success, and/or failure of the project; and any communications needed to ensure the project's success.

The user is also prompted to enter different possible implementation methods or approaches that may be used to execute the project, as well as the benefits and drawbacks, e.g., trade-offs, involved in each. Once the user has identified each approach that may be used to implement the project, the system prompts the user to identify factors related to each approach, such as whether each aspect of a particular approach is necessary in meeting the business objective, the costs associated with the each implementation approach (e.g., money, resources, and time), and whether each implementation approach will actually succeed in achieving the business purpose of the project. Therefore, once the above information is assembled, the project leader can select the most appropriate implementation method for the project, e.g., the method with the greatest benefits and the fewest drawbacks.

The Project Strategy execution module also prompts the user to identify any risks associated with the project's implementation plan, such as technical risks, operational risks, strategic or business risks, execution risks, and cultural or political risks, as well as potential impacts of those risks. Further, the user is prompted to identify any potential problems in aligning the interests of the stakeholders with the purpose of the project. Thereafter, the user begins the Leadership Integrator for the Project Strategy execution module.

According to one embodiment of the present invention, completion of the Project Strategy execution module concludes the Business Case category of execution modules. Thereafter, the user advances to the Implementation category, for example.

Implementation Category

One purpose of the Implementation category is to aid the project leader in developing and implementing the project. According to one embodiment of the present invention, the Implementation category includes execution modules, such as Project Plan, Project Tracking, and Uncertainty Management, as illustrated in FIG. 23.

The user begins the Implementation category, for example, by selecting the “Project Planning” button 2000, shown in FIG. 23, or by using the Image Map 1050, shown in FIG. 24.

The Project Planning execution module aids the project leader in creating a detailed plan for the execution of the project. First, the user lists each task involved in the key workstreams identified in the Project Strategy execution module. The user then enters the start and end dates for each task, the team member responsible for each task, and the occurrence of any event on which a task is dependent. The user also inputs key success factors, such as issues, activities, and/or decisions, that are critical to the success of the project's plan. Additionally, the user defines a leadership marker corresponding to each key factor. Leadership markers are qualitative indicators used by the project leader to determine whether the project is tracking properly. For example, if the project involves installation of new equipment, leadership markers may include: 1) completion of the appropriate equipment's selection; 2) submission of the necessary acquisition forms; 3) the delivery of the equipment; and 4) the installation of the equipment.

Next, the user identifies project milestones and time deadlines required to achieve the business purpose of the project. The user is also prompted to revise, if necessary, any metrics used for measuring the progress, success, and/or failure of the project. Thereafter, the Leadership Integrator for the Project Planning execution module begins.

After reviewing the Leadership Integrator for the Project Planning execution module, the user continues to the Project Tracking execution module, for example.

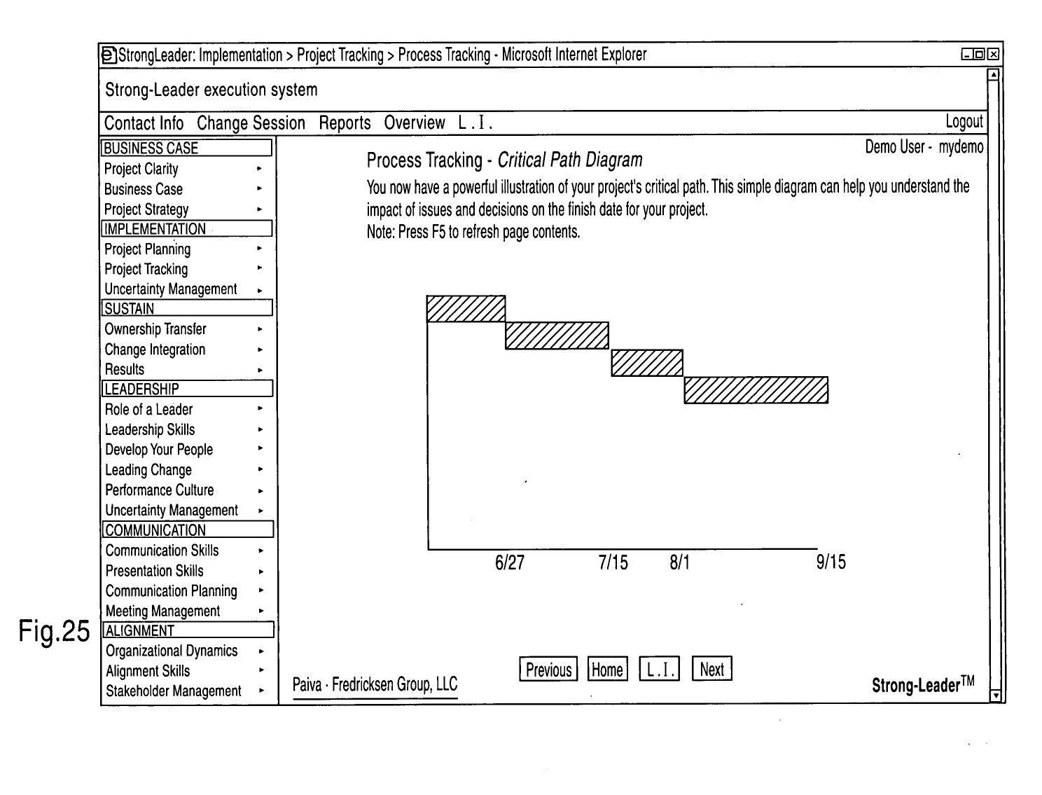

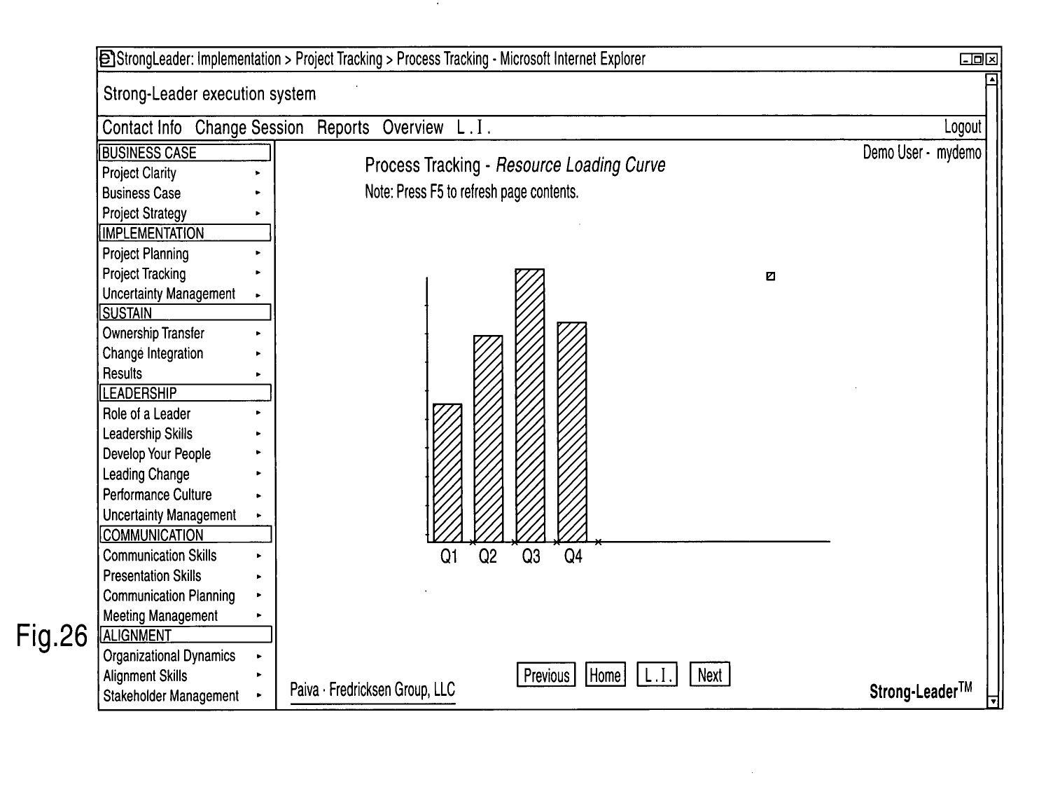

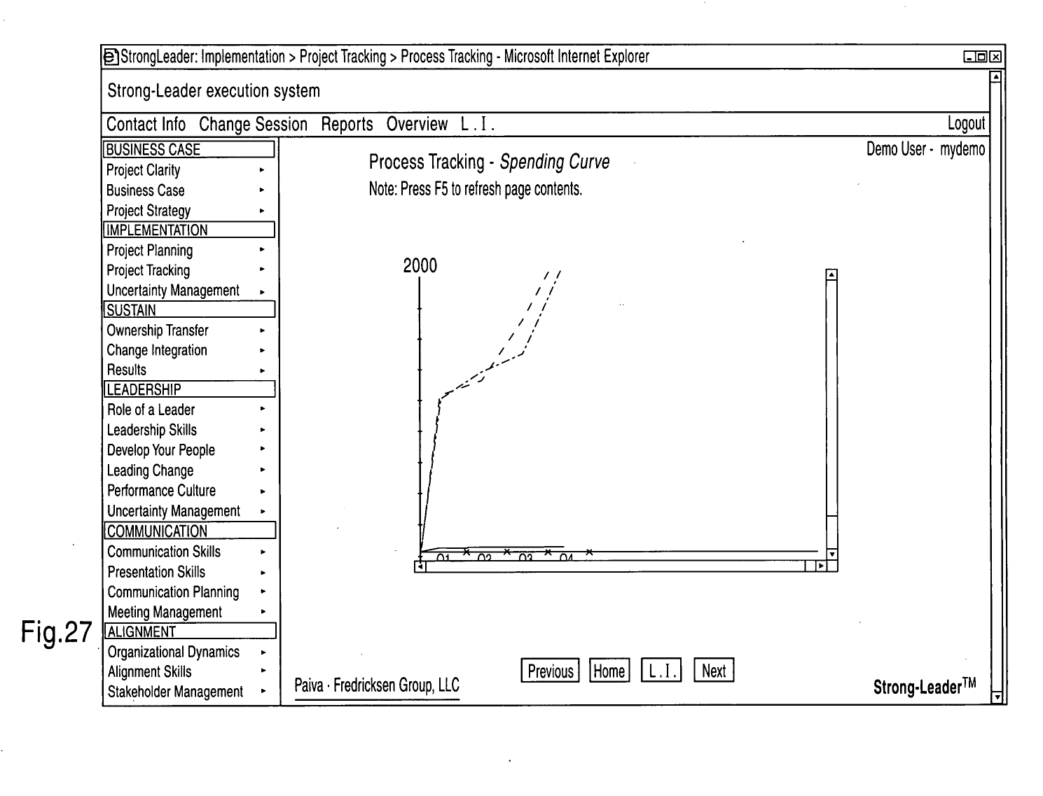

The Project Tracking execution module aids the project leader in gauging the progress of the project. In one embodiment of the present invention, the user identifies and inputs critical steps in the project and the respective start and end dates, all of which aid the project leader in determining how much time the project will require to be completed. The user then identifies any resources and the amount of those resources needed to complete each critical step of the project. Next, the user inputs a budget for the project. Moreover, throughout the course of the project, the project leader will update what portion of the budget has been spent in relation to the corresponding completion amount of the project. Once the requested information has been inputted, the system graphically displays the information, allowing the project leader to track the progress of the project. Examples of the graphically displayed information are illustrated in FIGS. 25-27.

The Project Tracking execution module also prompts the user to input the project milestones and project output or deliverables, the yearly quarter in which each of the milestones or deliverables is due, and whether the milestone or deliverable was completed on time. Finally, the user revisits the project's benefits to the stakeholders, determines whether those benefits have been realized, and provides the project leader with an opportunity to input appropriate action if a change in the stakeholders' benefits has occurred. Thereafter, the Leadership Integrator for the Project Tracking execution module begins.

The next execution module is entitled “Uncertainty Management.” A purpose of the Uncertainty Management execution module is to reduce or eliminate any influence adversely affecting the project. For example, the user inputs mitigation and contingency plans for each risk previously identified. Also, the user identifies any issues affecting the project, how the issues, are affecting the project, and any options for resolving the issues, along with the impact of those options upon the project. Finally, user identifies any changes or deviations occurring in the project; how the deviations are affecting aspects of the project, such as the project itself, the project metrics, the budget, and the project stakeholders; and a corresponding change control process for limiting the effects of the changes. The Leadership Integrator for the Uncertainty Management execution module then follows, and the Implementation category is completed.

Sustain Category

The user next continues with execution modules of the Sustain category by selecting the Ownership Transfer execution module, for example. A purpose of the Sustain category is to ensure that the project remains effective once control of the project is transferred to others within the business. For example, the Ownership Transfer execution module helps the project leader define what things need to occur within the client in order to integrate the project or the project's results into other parts of the business. According to one embodiment of the present invention, the Sustain category includes execution modules, such as Ownership Transfer, Change Integration, and Results.

A purpose of the Ownership Transfer execution module is to ensure that sufficient resources have been allotted to the project so that the project remains effective once transferred to other parts of the business. The user identifies any open items, lists the resources designated to complete the open items, and determines a target date for the completion of each item. Further, the Ownership Transfer execution module provides a further opportunity for the project leader to confirm whether the project's benefits to the stakeholders are being realized, if not, why not, and what changes must be made to ensure the realization of the benefits. Next, the user inputs key events that must transpire in order to ensure the project's benefits are realized by the business. That is, the user identifies what items must end or be eliminated and what new items need to be implemented in order to successfully introduce the project's results into the business. This allows the project leader to identify and address any existing issues that require attention to ensure proper implementation of the project within the business. Further, the user defines a metric and a success marker for each item so that progress of each item can be measured. Next, the user advances to the Leadership Integrator for the Ownership Transfer execution module.

The user then begins the Change Integration execution module. A purpose of the Change Integration execution module, for example, is to determine whether necessary changes have been implemented into the stakeholders' processes. Changes to the stakeholders' processes are necessary to ensure project benefits are achieved and sustained within the business. Accordingly, the user is prompted to identify whether changes to the stakeholders in areas, such as personnel, systems, and technology, have occurred. If not, the user formulates and inputs an action plan to bring the stakeholders into compliance and to provide appropriate metrics to measure the effectiveness of the action plan.

Thereafter, the user begins the Results execution module, which is typically used at completion of a project. In the course of completing the Results execution module, the user identifies any differences in planned results (defined in the Project Clarity execution module) and actual results obtained, the reasons for the differences, and a plan or plans to decrease or eliminate the differences. The user then inputs any lessons learned during execution of the project. For example, the project leader identifies lessons specific to the project, as well as lessons learned concerning business processes used to execute the project. Project specific lessons may relate to such areas as business benefit achievement, leadership, scope of the project, resources required, project workstreams, and project sustainability. Regarding lessons concerning business processes, the user may identify lessons relating to, for example, decision making, team dynamics, tools and support, communications, risks, issues identification and control, and project scope control.

Example embodiments of the present invention have now been described in accordance with the above advantages. It will be appreciated that these examples are merely illustrative of the invention. Many variations and modifications will be apparent to those skilled in the art.

1. A method for implementing and assessing idea implementation throughout an organization, the method comprising:
formulating an idea for implementation within the organization;
recording the idea;
disseminating the idea through at least one level of a hierarchal structure of the organization;
coaching members of the at least one hierarchal structure of the organization; and
tracking implementation of the idea;
wherein coaching ensures that the original idea is not altered once disseminated within the at least one level of the hierarchal structure of the organization.

2. The method of claim 1, wherein the idea is a business-wide strategy.

3. The method of claim 1, wherein coaching members of the at least one hierarchal structure of the organization includes at least one selected from a group consisting of:
identifying a purpose of the business idea;
planning for implementation of the business idea;
facilitating implementation of the business idea;
tracking implementation of the business idea; and
mitigating risks associated with implementing the business idea.

4. The method of claim 1, wherein the idea is a project having a defined goal.

5. The method of claim 4, wherein coaching members of the at least one hierarchal structure of the organization includes at least one selected from a group consisting of:
identifying a purpose of the project;
identifying effects of the project;
developing a plan for implementing the project;
developing a plan for monitoring the project during implementation;
minimizing risks associated with the project; and
developing a plan for sustaining implementation of the project.

6. The method of claim 1, wherein the method is implemented via a user interface.

7. The method of claim 6, wherein the coaching occurs via the user interface.

8. The method of claim 1, wherein tracking implementation of the business idea includes:
providing a score for the performance of at least one of the members.

9. The method of claim 1, wherein coaching members of the at least one hierarchal staff includes:
executing a project leader session.

10. The method of claim 9, wherein executing a project leader session includes executing at least one selected from a group consisting of a project clarity module, a business case module, a project strategy module, a project planning module, a project tracking module, an uncertainty management module, an ownership transfer module, a change integration module, and a results module.

11. The method of claim 1, wherein coaching members of the at least one hierarchal staff includes:
executing a functional leader session.

12. The method of claim 11, wherein executing a functional leader session includes executing at least one selected from a group consisting of a clarity module, a business planning module, an alignment and governance module, a performance tracking module, and an uncertainty management module.

13. The method of claim 1, wherein coaching members of the at least one hierarchal staff includes:
providing each of the members with access to a processor based device for collecting and analyzing coaching information.

14. The method of claim 13, wherein at least one user level is assigned to each of the members and to a coach.

15. The method of claim 14, wherein differing levels of access to the coaching information is provided, depending on the at least one user level.

16. A system for implementing and assessing a business idea throughout an organization, the system comprising:
means for formulating an idea for implementation within the organization;
means for recording the idea;
means for disseminating the idea through at least one level of a hierarchal structure of the organization;
means for coaching members of the at least one hierarchal structure of the organization; and
means for assessing performance of the members in implementing the idea;
wherein coaching ensures that the original idea is not altered once disseminated within the at least one level of the hierarchal structure of the organization.

17. A system for implementing and assessing a business idea throughout an organization, the system comprising:
a terminal; and
a data repository;
wherein an idea is formulated for implementation within the organization;
wherein the idea is recorded to the data repository;
wherein the idea is disseminated through at least one level of a hierarchal structure of the organization via the terminal;
wherein members of the at least one hierarchal structure of the organization are coached, the coaching ensuring that the original idea is not altered once disseminated within the at least one level of the hierarchal structure of the organization; and
wherein performance of the members is assessed in implementing the idea.

18. The system of claim 17, wherein the terminal is coupled to a server.

19. The system of claim 18, wherein the terminal is coupled to the server via a network.

20. The system of claim 19, wherein the network is the Internet.

21. The system of claim 17, wherein the terminal is selected from a group consisting of a personal computer, a minicomputer, a main frame computer, a microcomputer, a telephone device, and a hand-held device.
